(19) United States
(12) Patent Application Publication
(10) Pub. No.: US 2024/0073800 A1
(43) Pub. Date: Feb. 29, 2024

(54) TECHNIQUES FOR INDICATING NETWORK OPERATION MODE IN WIRELESS COMMUNICATIONS

(71) Applicant: QUALCOMM Incorporated, San Diego, CA (US)

(72) Inventors: Ahmed Attia Abotabl, San Diego, CA (US); Yu Zhang, San Diego, CA (US); Hung Dinh Ly, San Diego, CA (US)

(21) Appl. No.: 17/897,023

(22) Filed: Aug. 26, 2022

(51) Int. Cl. H04W 48/18; H04W 72/04

(52) U.S. Cl. CPC H04W 48/18; H04W 72/042; H04W 88/06

(57) ABSTRACT

Methods, systems, and devices for wireless communications are described in which a network entity may operate using multiple operation modes, where different operation modes are associated with different energy consumption. A network entity may provide one or more user equipment (UE) with a set of operation modes, and each operation mode of the set of operation modes may be selectable for communications between the one or more UEs and the network entity for associated time intervals. The network entity and one or more UEs may communicate using a first operation mode, and the network entity may provide an indication of a second operation mode (e.g., a lower power mode). Based on the indication of the second operation mode, the one or more UEs and the network entity may communicate according to the second operation mode for the time interval associated with the second operation mode.

### FIELD OF TECHNOLOGY

The following relates to wireless communications, including techniques for indicating network operation mode in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for indicating network operation mode in wireless communications. For example, the described techniques provide for multiple operation modes at a network entity, where different operation modes are associated with different energy consumption at the network entity, and an operation mode may be selected for communications with a user equipment (UE) based on an energy consumption associated with the operation mode. In some cases, a network entity (e.g., a base station) may provide one or more UEs with a set of operation modes associated with the network entity, where multiple different operation modes are associated with different energy consumption at the network entity, and each operation mode of the set of operation modes selectable for communications between a UE and the network entity for one or more identified time intervals. The network entity and a first UE may communicate using a first operation mode, and the network entity may provide an indication of a second operation mode (e.g., a lower energy consumption operation mode). Based on the indication of the second operation mode, the first UE and the network entity may communicate according to the second operation mode for a time interval associated with the second operation mode.

In some cases, configuration information (e.g., radio resource control (RRC) signaling) may provide the set of operation modes and corresponding sets of communications parameters associated with each operation mode, and switching between operation modes is based on an indication of the operation mode and an associated time interval. In some cases, control information from the network entity (e.g., downlink control information (DCI)) may indicate the time interval during which the second operation mode is active. In some cases, the control information may be provided in a group-common DCI (GC-DCI) communication that indicates different operation modes for different UEs that receive the GC-DCI.

A method for wireless communication at a user equipment (UE) is described. The method may include receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals, communicating with the network entity according to the first operation mode using the first set of communications parameters, receiving control information that indicates the network entity is operating in the second operation mode for a first time interval, and communicating with the network entity according to the second operation mode using the second set of communications parameters for the first time interval associated with the second operation mode.

An apparatus for wireless communication at a UE is described. The apparatus may include a processor, memory coupled with the processor, and instructions stored in the memory. The instructions may be executable by the processor to cause the apparatus to receive a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals, communicate with the network entity according to the first operation mode using the first set of communications parameters, receive control information that indicates the network entity is operating in the second operation mode for a first time interval, and communicate with the network entity according to the second operation mode using the second set of communications parameters for the first time interval associated with the second operation mode.

Another apparatus for wireless communication at a UE is described. The apparatus may include means for receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals, means for communicating with the network entity according to the first operation mode using the first set of communications parameters, means for receiving control information that indicates the network entity is operating in the second operation mode for a first time interval, and means for communicating with the network entity according to the second operation mode using the second set of communications parameters for the first time interval associated with the second operation mode.

A non-transitory computer-readable medium storing code for wireless communication at a UE is described. The code may include instructions executable by a processor to receive a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals, communicate with the network entity according to the first operation mode using the first set of communications parameters, receive control information that indicates the network entity is operating in the second operation mode for a first time interval, and communicate with the network entity according to the second operation mode using the second set of communications parameters for the first time interval associated with the second operation mode.

In some examples of the method, apparatuses, and non-transitory computer-readable medium described herein, the receiving the set of operation modes may include operations, features, means, or instructions for receiving radio resource control (RRC) signaling that indicates two or more operation modes of the set of operation modes, and that indicates corresponding sets of communications parameters associated with each operation mode of the two or more operation modes, and where different operation modes of the set of operation modes are associated with different energy usage at the network entity. In some examples of the method, apparatuses, and non-transitory computer-readable medium described herein, the control information indicates the first time interval during which the second operation mode is active. In some examples of the method, apparatuses, and non-transitory computer-readable medium described herein, the control information is provided in a group-common downlink control information (GC-DCI) communication that indicates different operation modes for different UEs that receive the GC-DCI.

In some examples of the method, apparatuses, and non-transitory computer-readable medium described herein, the receiving the set of operation modes may include operations, features, means, or instructions for receiving a timer value associated with each operation mode of the set of operation modes, and where the UE communicates with the network entity according to the first operation mode subsequent to an expiration of a timer that is set based on the timer value associated with the second operation mode. In some examples of the method, apparatuses, and non-transitory computer-readable medium described herein, the first time interval is indicated in the control information as a selected time interval of a set of available time intervals, or as a number of symbols, slots, or frames associated with the second operation mode. In some examples of the method, apparatuses, and non-transitory computer-readable medium described herein, the first time interval corresponds to a time duration until a subsequent control information transmission indicates a different operation mode of the set of operation modes. Some examples of the method, apparatuses, and non-transitory computer-readable medium described herein may further include operations, features, means, or instructions for skipping one or more decoding attempts for one or more control information transmissions during the first time interval.

Some examples of the method, apparatuses, and non-transitory computer-readable medium described herein may further include operations, features, means, or instructions for communicating with the network entity based on one or more communications parameters associated with a default operation mode when a subsequent control information transmission that indicates a new operation mode is undetected prior to an expiration of the first time interval. Some examples of the method, apparatuses, and non-transitory computer-readable medium described herein may further include operations, features, means, or instructions for receiving an indication of the default operation mode in RRC signaling. Some examples of the method, apparatuses, and non-transitory computer-readable medium described herein may further include operations, features, means, or instructions for communicating with the network entity according to the second operation mode subsequent to an expiration of the first time interval and until a subsequent control information transmission indicates a different operation mode.

In some examples of the method, apparatuses, and non-transitory computer-readable medium described herein, the receiving the control information may include operations, features, means, or instructions for receiving a GC-DCI communication that includes two or more different operation mode indications for two or more different UEs and determining which of the two or more different operation mode indications corresponds to the second operation mode based on a location of information in the GC-DCI. In some examples of the method, apparatuses, and non-transitory computer-readable medium described herein, a network operation field in the GC-DCI indicates which operation mode of the set of operation modes is to be used for communications, or indicates a sequence of different operation modes for different time intervals. Some examples of the method, apparatuses, and non-transitory computer-readable medium described herein may further include operations, features, means, or instructions for receiving a radio network temporary identifier (RNTI) associated with operation modes that is to be used for communications with the network entity, and where the GC-DCI is received based on the RNTI.

Some examples of the method, apparatuses, and non-transitory computer-readable medium described herein may further include operations, features, means, or instructions for communicating, with the network entity subsequent to an expiration of the first time interval according to a default operation mode in an absence of a subsequent control information communication that indicates a new operation mode.

A method for wireless communication at a network entity is described. The method may include transmitting, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals, communicating with the first UE according to the first operation mode using the first set of communications parameters, transmitting control information to the first UE that includes an indication to switch to the second operation mode and a first time interval associated with the second operation mode, the indication to switch to the second operation mode based on an energy usage associated with each of the first operation mode and the second operation mode, and communicating with the first UE according to the second operation mode using the second set of communications parameters for the first time interval associated with the second operation mode.

An apparatus for wireless communication at a network entity is described. The apparatus may include a processor, memory coupled with the processor, and instructions stored in the memory. The instructions may be executable by the processor to cause the apparatus to transmit, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals, communicate with the first UE according to the first operation mode using the first set of communications parameters, transmit control information to the first UE that includes an indication to switch to the second operation mode and a first time interval associated with the second operation mode, the indication to switch to the second operation mode based on an energy usage associated with each of the first operation mode and the second operation mode, and communicate with the first UE according to the second operation mode using the second set of communications parameters for the first time interval associated with the second operation mode.

Another apparatus for wireless communication at a network entity is described. The apparatus may include means for transmitting, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals, means for communicating with the first UE according to the first operation mode using the first set of communications parameters, means for transmitting control information to the first UE that includes an indication to switch to the second operation mode and a first time interval associated with the second operation mode, the indication to switch to the second operation mode based on an energy usage associated with each of the first operation mode and the second operation mode, and means for communicating with the first UE according to the second operation mode using the second set of communications parameters for the first time interval associated with the second operation mode.

A non-transitory computer-readable medium storing code for wireless communication at a network entity is described. The code may include instructions executable by a processor to transmit, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals, communicate with the first UE according to the first operation mode using the first set of communications parameters, transmit control information to the first UE that includes an indication to switch to the second operation mode and a first time interval associated with the second operation mode, the indication to switch to the second operation mode based on an energy usage associated with each of the first operation mode and the second operation mode, and communicate with the first UE according to the second operation mode using the second set of communications parameters for the first time interval associated with the second operation mode.

In some examples of the method, apparatuses, and non-transitory computer-readable medium described herein, the transmitting the set of operation modes may include operations, features, means, or instructions for transmitting RRC signaling that indicates two or more operation modes of the set of operation modes, and that indicates corresponding sets of communications parameters associated with each operation mode of the two or more operation modes, and where different operation modes of the set of operation modes are associated with different energy usage. In some examples of the method, apparatuses, and non-transitory computer-readable medium described herein, the control information indicates the first time interval during which the second operation mode is active. In some examples of the method, apparatuses, and non-transitory computer-readable medium described herein, the control information is provided in a GC-DCI communication that indicates different operation modes for different UEs that receive the GC-DCI.

In some examples of the method, apparatuses, and non-transitory computer-readable medium described herein, the transmitting the set of operation modes may include operations, features, means, or instructions for transmitting a timer value associated with each operation mode of the set of operation modes, and where the first UE communicates with the network entity according to the first operation mode subsequent to an expiration of a timer that is set based on the timer value associated with the second operation mode. In some examples of the method, apparatuses, and non-transitory computer-readable medium described herein, the first time interval is indicated in the control information as a selected time interval of a set of available time intervals, or as a number of symbols, slots, or frames associated with the second operation mode.

Some examples of the method, apparatuses, and non-transitory computer-readable medium described herein may further include operations, features, means, or instructions for communicating with the first UE based on one or more communications parameters associated with a default operation mode when a subsequent control information transmission that indicates a new operation mode is not transmitted prior to an expiration of the first time interval. Some examples of the method, apparatuses, and non-transitory computer-readable medium described herein may further include operations, features, means, or instructions for transmitting an indication of the default operation mode in RRC signaling. In some examples of the method, apparatuses, and non-transitory computer-readable medium described herein, the transmitting the control information may include operations, features, means, or instructions for transmitting a GC-DCI communication that includes two or more different operation mode indications for at least the first UE and a second UE, and where different locations in the GC-DCI are associated with the first UE and the second UE and the operation mode for each UE is provided in a corresponding location in the GC-DCI.

### BRIEF DESCRIPTION OF THE DRAWINGS

FIG. 1 illustrates an example of a wireless communications system that supports techniques for indicating network operation mode in wireless communications in accordance with one or more aspects of the present disclosure.

FIG. 2 illustrates an example of a wireless communications system that supports techniques for indicating network operation mode in wireless communications in accordance with one or more aspects of the present disclosure.

FIG. 3 illustrates an example of operation mode transitions that support techniques for indicating network operation mode in wireless communications in accordance with one or more aspects of the present disclosure.

FIG. 4 illustrates an example of operation mode transitions that support techniques for indicating network operation mode in wireless communications in accordance with one or more aspects of the present disclosure.

FIG. 5 illustrates an example of a process flow that supports techniques for indicating network operation mode in wireless communications in accordance with one or more aspects of the present disclosure.

FIGS. 6 and 7 show block diagrams of devices that support techniques for indicating network operation mode in wireless communications in accordance with one or more aspects of the present disclosure.

FIG. 8 shows a block diagram of a communications manager that supports techniques for indicating network operation mode in wireless communications in accordance with one or more aspects of the present disclosure.

FIG. 9 shows a diagram of a system including a device that supports techniques for indicating network operation mode in wireless communications in accordance with one or more aspects of the present disclosure.

FIGS. 10 and 11 show block diagrams of devices that support techniques for indicating network operation mode in wireless communications in accordance with one or more aspects of the present disclosure.

FIG. 12 shows a block diagram of a communications manager that supports techniques for indicating network operation mode in wireless communications in accordance with one or more aspects of the present disclosure.

FIG. 13 shows a diagram of a system including a device that supports techniques for indicating network operation mode in wireless communications in accordance with one or more aspects of the present disclosure.

FIGS. 14 through 20 show flowcharts illustrating methods that support techniques for indicating network operation mode in wireless communications in accordance with one or more aspects of the present disclosure.

### DETAILED DESCRIPTION

A wireless communications system may include a communication device, such as a user equipment (UE) or a network entity (e.g., an eNodeB (eNB), a next-generation NodeB or a giga-NodeB, either of which may be referred to as a gNB, or some other base station), that support wireless communications over one or multiple radio access technologies. Examples of radio access technologies include 4G systems, such as LTE systems, 5G systems, which may be referred to as NR systems, or other radio access technologies. The wireless communications may include uplink transmission, uplink reception, downlink transmission, or downlink reception, sidelink transmission, sidelink reception, or a combination thereof. A communication device may be configured with various circuitry to support wireless communications. In some cases, this various circuitry may include multiple circuit elements, such as multiple transmit/receive chains that each have associated power amplifier, mixer, and filtering components, among others, for example. When transmitting via multiple antenna ports, multiple active transmit chains may consume relatively large amounts of power.

This large energy consumption may be driven in part by a relatively large number of antennas at a network entity (e.g., gNBs, radio heads, etc.). For example, if a network entity uses all of its antennas, energy consumption can increase by a relatively large amount relative to cases where fewer than all antennas are used for communications. In some cases, network power savings may be achieved by using fewer than all of the antennas at a network-side transmitter (e.g., by using 16 antenna ports instead of 32 antenna ports at a network entity for wireless communications). However, switching from a larger number of antenna ports to a reduced number of antenna ports involves reconfiguring of served UEs with parameters that are based on the different numbers of antenna ports, which can take time and increase overhead. Thus, efficient techniques to configure and indicate a network operation mode may be desirable in order to reduce network power consumption through switching to different operation modes that use different numbers of antennas, while also allowing efficient signaling with low overhead.

In accordance with various aspects discussed herein, transmission parameters for multiple different network operation modes, such as modulation and coding scheme (MCS) and transmission power, based on a number of active antenna ports may be preconfigured at UEs, and an indication in downlink control information (DCI) may signal a network operation mode and an interval associated with how long the network operation mode will be used. UEs that receive such an indication may use the configured parameters for communications for the time interval associated with the indicated operation mode. In some cases, a network entity may transmit periodic DCI indications of a network operation mode for an upcoming time interval. The DCI may indicate which of multiple different RRC configured modes is selected, and the interval for which the mode is going to be active. In some cases, the DCI may be a group-common DCI (GC-DCI) that indicates different network operation types for different UEs. In some cases, the interval for the indicated network operation mode may be based on a timer that is configured with each network operation mode, such as a number of symbols/slots/frames associated with the network operation mode. In some cases, an operation mode may continue until a subsequent DCI indicates to change. In some cases, the UE may skip decoding one or more DCIs during the time interval (e.g., not attempt to decode a DCI for one or more DCI monitoring occasions within the time interval). In some cases, if a new DCI to indicate a subsequent network operation mode is not received prior to the end of the time interval, the UE may assume a default operation for the remaining time interval until a following DCI (e.g., a default operation mode may be RRC configured), or the UE may extend the current operation mode until receipt of a following DCI.

Techniques as discussed herein may provide for enhanced flexibility in selection of operating modes at a network entity, while signaling changes to operation modes in an efficient manner. In some cases, a network entity may use different operation modes concurrently for different UEs. For example, a first UE may receive an indication that the network entity is operating in a reduced power operation mode (e.g., using 16 antenna ports) and may use communications parameters associated with the reduced power operation mode (e.g., MCS, redundancy version (RV) index, transport block (TB) size, TB scaling factor, etc.), while a second UE communicates with the network entity according to a higher power operation mode (e.g., using 32 antenna ports). In some cases, a DCI (e.g., GC-DCI) may contain multiple network operation mode indications addressed for different UEs, such as by using different locations of indications in the DCI (e.g., location in DCI) configured for different UEs, or a UE may be configured with a radio network temporary identifier (RNTI) for an operation mode DCI and may operate in accordance with an operation mode indicated in a DCI associated with the configured RNTI. Such techniques may allow network entities to reduce operating power, while providing flexible and efficient techniques to indicate operation modes to served devices.

Aspects of the disclosure are initially described in the context of wireless communications systems. Aspects of the disclosure are further illustrated by and described with reference to operation mode diagrams, process flows, apparatus diagrams, system diagrams, and flowcharts that relate to techniques for indicating network operation mode in wireless communications.

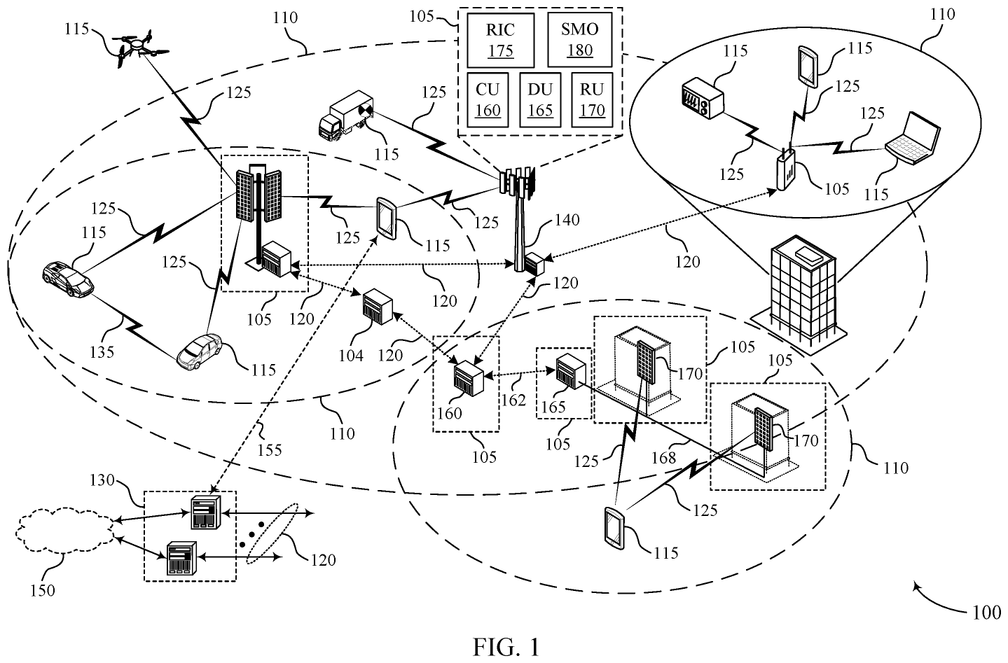

FIG. 1 illustrates an example of a wireless communications system 100 that supports techniques for indicating network operation mode in wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for indicating network operation mode in wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, one or more network entities 105 may use multiple different operation modes that are associated with different energy consumption, and an operation mode may be selected for communications with one or more UEs 115 based on an energy consumption associated with the operation mode. In some cases, a network entity 105 may provide one or more UEs 115 with a set of operation modes associated with the network entity, where multiple different operation modes are associated with different energy consumption at the network entity, and each operation mode of the set of operation modes selectable for communications between a UE 115 and the network entity 105 for one or more identified time intervals.

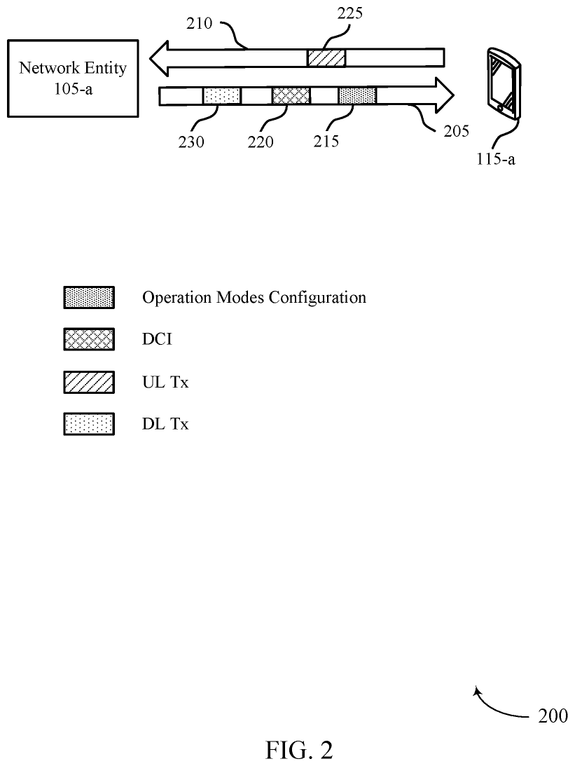

FIG. 2 illustrates an example of a wireless communications system 200 that supports techniques for indicating network operation mode in wireless communications in accordance with one or more aspects of the present disclosure. The wireless communications system 200 may implement or be implemented by aspects of the wireless communications system 100 as described in FIG. 1. For example, the wireless communications system 200 may include a network entity 105-a and a UE 115-a, which may be examples of network entities 105 and UEs 115 as described with reference to FIG. 1. In some examples, the wireless communications system 200 may support multiple radio access technologies including 4G systems such as LTE systems, LTE-A systems, or LTE-A Pro systems, and 5G systems which may be referred to as NR systems. The wireless communications system 200 may support power saving, and, in some examples, may promote wireless communications in which operation modes of the network entity 105-a may be selected based at least in part on power consumption considerations, and selected operation modes signaled to the UE 115-a for use in wireless communications for a time interval associated with the selected operation mode.

One or more of the network entity 105-a or the UE 115-a, or any combination thereof, may be equipped with multiple antennas, which may be used to employ techniques as described with reference to FIG. 1. The antennas of one or more of the network entity 105-a or the UE 115-a, or any combination thereof, may be located within one or more antenna arrays or antenna panels, which may support operations as described herein. The network entity 105-a, the network entity 105-b, or both, may have an antenna array with a number of rows and columns of antenna ports that the network entity 105-a may use to support wireless communications (e.g., with the UE 115-a). Likewise, the UE 115-a may have one or more antenna arrays that may support various operations as described herein.

In the example of FIG. 2, the UE 115-a and network entity 105-a may communicate via at least one downlink channel 205 and at least one uplink channel 210. Network entity 105-a may use downlink channel 205 to convey control and/or data information to UE 115-a. And UE 115-a may use uplink channel 210 to convey control and/or data information to the network entity 105-a. In some cases, downlink channel 205 may use different time and/or frequency resources than uplink channel 210. In some cases, the network entity 105-a may transmit operation modes configuration information 215 via downlink channel 205. The operation modes configuration information 215 may be transmitted, for example, using RRC signaling that provides multiple different operation modes and associated communications parameters. For example, transmission parameters for multiple different network operation modes may be provided in a table in which index values of different operation modes have associated transmission parameters, such as MCS, RV index, TB size, TB scaling factor, etc. In some cases, different operation modes may have associated timer values (e.g., a time interval associated with the corresponding operation mode, or a number of frames/slots/symbols associated with the corresponding operation mode), and the UE 115-a may operate according to the operation mode for a time interval that is based on the associated timer value.

In some cases, the network entity 105-a may transmit a DCI 220 that may signal a network operation mode and, optionally, an interval associated with how long the network operation mode will be used. For example, DCI 220 may provide an indication that a reduced power operation mode is to be used for an upcoming time interval, such as by providing an indication of the operation mode (e.g., an index value that indicates one of the set of configured operation modes) and a time interval (e.g., number of slots) during which the network entity 105-a will operate using the indicated operation mode. The UE 115-a, upon receipt of the DCI 220, may use the configured parameters for uplink communications 225 and downlink communications 230 for the time interval associated with the indicated operation mode. In some cases, the network entity 105-a may transmit periodic DCI 220 indications of a network operation mode for an upcoming time interval, that indicate which of multiple different RRC configured modes is selected. In some cases, the DCI 220 may be a GC-DCI that indicates different network operation types for different UEs 115. In some cases, the interval for the indicated network operation mode may be based on a timer that is configured with each network operation mode, such as a number of symbols/slots/frames associated with the network operation mode. In some cases, an operation mode may continue until a subsequent DCI 220 indicates to change.

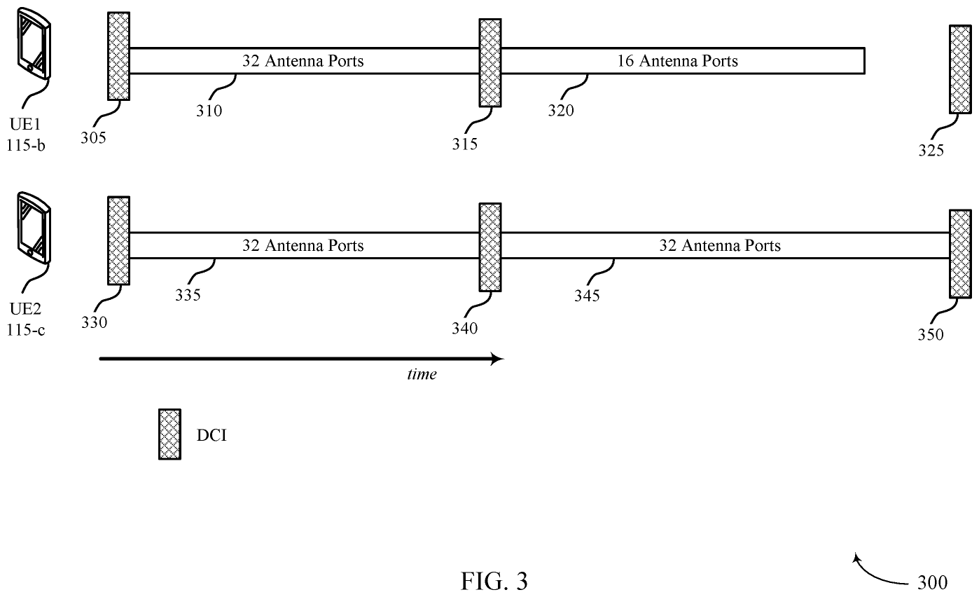

Such techniques may provide for reduced power consumption at the network side, where the network may decide to get into different energy saving mode or operations. In some case, network entity 105-a may change the operation mode depending on the traffic load at the network entity 105-a. For example, the network entity 105-a may reduce the number of antenna elements used for downlink communications 230 in cases where network loading is relatively low. The configuration of multiple different operation modes that are selectable and indicated in DCI 220 may allow for dynamic switching of operation modes with relatively low latency and overhead, and may provide flexibility for operation mode selection at the network entity 105-a. FIGS. 3 through 5 provide various examples for such different operation modes, and configuration/switching for multiple different operation modes.

FIG. 3 illustrates an example of operation mode transitions 300 that support techniques for indicating network operation mode in wireless communications in accordance with one or more aspects of the present disclosure. The example of operation mode transitions 300 may represent characteristics of communications in aspects of the wireless communications systems 100 and 200 as described with reference to FIGS. 1 and 2, respectively.

In this example, a first UE 115-b and a second UE 115-c may be served by a network entity (e.g., a network entity 105 of FIGS. 1 and 2), and may be configured with a set of operation modes as discussed herein. For example, the network entity may configure each of the first UE 115-b and the second UE 115-c with multiple different operation modes, and corresponding communications parameters for each operation mode (e.g., modulation order, coding rate, MCS index value, TB size, etc.). The first UE 115-b, in this example, may receive a first DCI 305 that includes an indication of a first operation mode 310 (e.g., a regular or default power operation mode using 32 antenna ports at the network entity). A second DCI 315 may be provided to the first UE 115-b that indicates a second operation mode 320 at the network entity. In this example, the second operation mode 320 may use 16 antenna ports at the network entity, and is thus a reduced power operation mode. In order to provide sufficient communications reliability using fewer antenna ports, communications parameters associated with the second operation mode 320 may be adjusted relative to the first operation mode 310, such as by providing a lower modulation order and/or lower coding rate (e.g., that may be indicated by an MCS index value), providing additional repetitions, increasing transmit power, or any combinations thereof). In some examples, the second DCI 315 may provide an index value to the second operation mode. Further, in some cases, the second DCI 315 may provide an indication of a time interval associated with the second operation mode. In other cases, the time interval associated with the second operation mode may be configured with the configuration information for the set of operation modes.

Further, as discussed herein, in some cases a network entity may use different operation modes concurrently with different UEs 115. In this example, the network entity may communicate with the second UE 115-c using a third operation mode 335 with 32 antenna ports, which may be indicated in third DCI 330. Further, the network entity may transmit fourth DCI 340 that indicates a fourth operation mode 345 for the second UE 115-c, which uses 32 antenna ports. In this example, the first UE 115-b is configured with the reduced power second operation mode 320 that uses 16 antenna ports, while the second UE 115-c is concurrently configured with a normal power fourth operation mode 345 that uses 32 antenna ports. Such different operation modes may allow the network entity flexibility in scheduling higher priority or lower latency communications with the second UE 115-c using a higher power operation mode, while scheduling lower priority or lower latency communications with the first UE 115-b using a lower power operation mode. In the example of FIG. 3, a subsequent fifth DCI 325 may provide an indication of a subsequent operation mode for the first UE 115-b (e.g., reverting back to the first operation mode 310 or continuing the second operation mode 310), and a subsequent sixth DCI 350 may provide an indication of a subsequent operation mode for the second UE 115-c (e.g., continuing the fourth operation mode 345 or switching to a fifth operation mode that uses a different number of network entity antenna ports).

In some cases, the network entity may transmit control information associated with each time interval that indicates the corresponding operation mode (e.g., DCI contents may include an indication of network energy saving mode among multiple RRC configured modes and the interval for which this mode is going to be active). In some cases, the control information may be provided by a GC-DCI which may indicate different network operation types for different UEs.

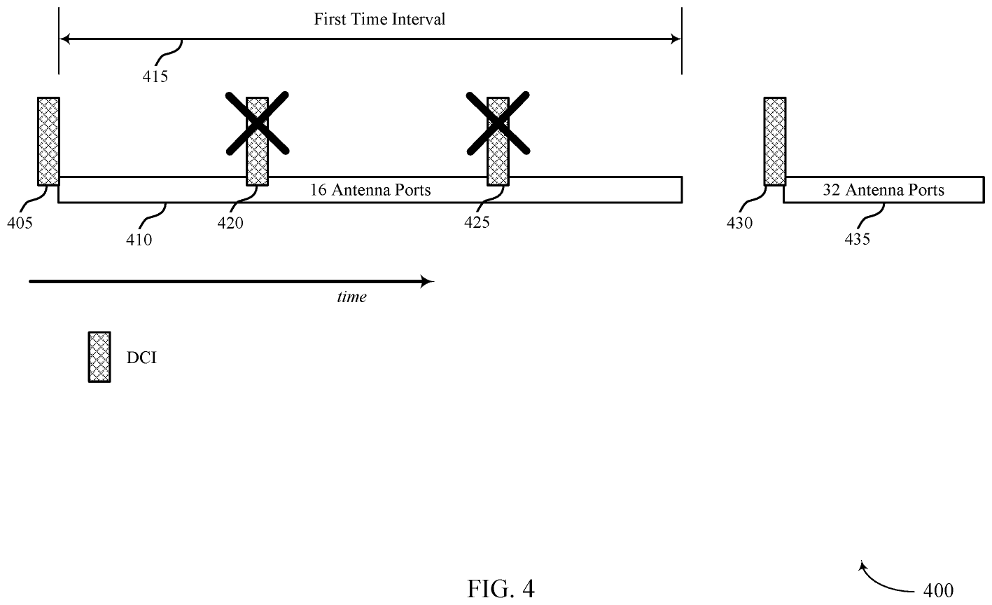

In accordance with various aspects, the time intervals associated with each operation mode may be provided to the UEs 115 using or more techniques. In some cases, each network operation mode may be configured with a timer such that the network goes back to a reference operation mode after the timer expiry (e.g., RRC configuration information provides a time interval associated with each operation mode and a reference operation mode). In other cases, the time interval for an operation mode may be indicated in the control information in terms of number of symbols/slots/frames or one of two or more RRC configured time intervals (e.g., RRC configuration may provide a list of available time intervals and the DCI may indicate which interval from the list applies to an indicated operation mode). In some cases, a signaled operation mode may be maintained until a subsequent DCI indication that might signal a change (or not) of the operation mode. In some cases, if the indicated interval is longer than the time until the following DCI indication, the UE may skip decoding of one or more intervening DCIs, as will be discussed in more detail with reference to FIG. 4. Such a technique may save energy at the UE, and also the network may not need to send such a DCI.

In some cases, such as illustrated in FIG. 3 for the second operation mode 320, the indicated interval for the operation mode may expire before the following DCI indication of the network operation, corresponding to fifth DCI 325 in this example. In such cases, the first UE 115-b may assume a default operation for the remaining time interval until the following DCI (e.g., an RRC configured default or reference operation mode). In other cases, the first UE 115-b may extend its the current operation mode until the following DCI, corresponding to an extension of the second operation mode 320 until the fifth DCI 325 in the example of FIG. 3.

As discussed, the DCI transmitted by a serving network entity may include a payload that indicates the operation mode and, in some case, an associated timer interval. In some cases, the DCI may be a GC-DCI that includes multiple network operation modes addressed for different UEs 115 (e.g., the first DCI 305 and the third DCI 310 are provided in a same GC-DCI). In such cases, each UE 115 may be configured with a location in the GC-DCI that indicates the corresponding network operation mode (e.g., each UE 115 may be configured with a location in DCI to read the corresponding network operation mode from the GC-DCI). The content of the network operation mode field in the DCI may indicate, for example, a preconfigured or specified correspondence to either a specific network operation mode or a sequence of operation modes and an associated periodicity (e.g., a sequence of operation modes with associated timer intervals for each mode of the sequence). Additionally, in some cases, the DCI may provide (e.g., in a same indication/table, or in a different field) the associated time interval for which the indicated operation mode will be active. In some cases, the UEs 115 may identify DCI based on a RNTI that is configured at the UE 115 for decoding DCI that indicates network operation modes, such that the network entity may address different DCIs to different UEs based on the associated RNTIs.

As discussed, in some cases, a UE 115 may not detect a DCI that provides an updated network operation mode prior to expiration of a time interval associated with a previously indicated operation mode. In some cases, if the interval indicated in a last decoded DCI is about to end and the UE 115 does bit receive a new DCI indication, the UE 115 may fall back to a pre-configured default or reference network operation mode. For example, if the UE 115 fails to detect a DCI indicating the network operation mode, the UE 115 may assume no change in the current network operation mode, may assume a default or reference network operation mode (e.g., that is RRC configured), may assume a legacy operation mode (e.g., an operation mode associated with initial network access), or may assume a network sleep mode (e.g., assume no further resource allocations are to be received until after a subsequent monitoring occasion for a DCI that indicates a network operation mode).

Techniques such as discussed herein thus may provide for enhanced flexibility in selection of operating modes at a network entity, while signaling changes to operation modes in an efficient manner. Such techniques may allow network entities to reduce operating power, while providing flexible and efficient techniques to indicate operation modes to served devices.

FIG. 4 illustrates an example of operation mode transitions 400 that support techniques for indicating network operation mode in wireless communications in accordance with one or more aspects of the present disclosure. The example of operation mode transitions 400 may represent characteristics of communications in aspects of the wireless communications systems 100 and 200 as described with reference to FIGS. 1 and 2, respectively.

In this example, a UE (e.g., a UE of FIGS. 1 through 3) may be served by a network entity (e.g., a network entity of FIGS. 1 through 3), and may be configured with a set of operation modes as discussed herein. For example, the network entity may configure the UE with multiple different operation modes, and corresponding communications parameters for each operation mode (e.g., modulation order, coding rate, MCS index value, TB size, etc.). As discussed herein, in some cases a time interval associated with an operation mode may span one or more DCI monitoring occasions during which the UE may monitor for DCI that indicates a new operation mode. In the example of FIG. 4, the UE may receive a first DCI 405 that indicates a first operation mode 410 (e.g., that uses 16 antenna ports at the network entity) and a first time interval 415. The UE also may be configured with DCI monitoring occasions for monitoring a second DCI 420 and a third DCI 425 that are both within the first time interval 415. In such cases, the UE may refrain from monitoring for the second DCI 420 and the third DCI 425, and may monitor for a fourth DCI 430 in a DCI monitoring occasions that is subsequent to the first time interval 415 (e.g., that indicates a second operation mode 435 that uses 32 antenna ports at the network entity. As discussed herein, the first DCI 405, second DCI 420, third DCI 425, and fourth DCI 430 may be DCIs that provide information related to network operation modes, such as GC-DCIs or DCIs scrambled with a RNTI associated with the UE during associated monitoring occasions. In some cases, one or more other DCIs may be received at the UE, such as DCIs that provide resource allocation and scheduling information for communications according to the first operation mode 410 (e.g., DCIs that are scrambled with a UE RNTI associated with scheduling DCIs, which may be received in corresponding scheduling DCI monitoring occasions that may occur in the same or different monitoring occasions as DCIs that indicate operation modes).

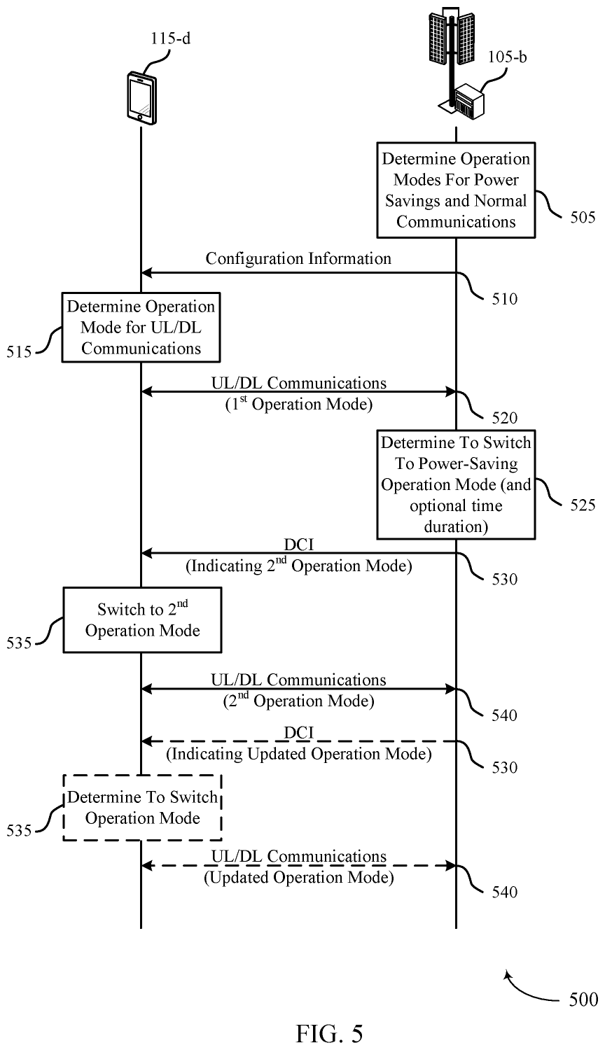

FIG. 5 illustrates an example of a process flow 500 that supports techniques for indicating network operation mode in wireless communications in accordance with one or more aspects of the present disclosure. In some examples, the process flow 500 may implement or be implemented by aspects of the wireless communications system 100 and the wireless communications system 200 as described with reference to FIGS. 1 and 2, respectively. For example, the process flow 500 may be implemented by a network entity 105-b and a UE 115-d, which may be examples of a network entity 105 and a UE 115 as described with reference to FIGS. 1 through 4. The process flow 500 may be implemented by the network entity 105-b and the UE 115-d to exchange signaling to promote network entity power saving and reliable communications between one or more of the network entity 105-b and the UE 115-d. In the following description of the process flow 500, the operations between the network entity 105-b and the UE 115-d may be transmitted in a different order than the example order shown, or the operations performed by the network entity 105-b and the UE 115-d may be performed in different orders or at different times. Some operations may also be omitted from the process flow 500, and other operations may be added to the process flow 500.

At 505, the network entity 105-b may determine two or more operation modes for power savings and normal communications. For example, the network entity 105-b may determine a first operation mode for normal or regular communications in which a full set of available antenna ports may be used for communications (e.g., 32 antenna ports), and may determine a second operation mode for power savings communications in which less than the full set of available antenna ports may be used for communications (e.g., 16 antenna ports). In some cases, the network entity 105-b may determine one or more conditions associated with each operation mode, such as an amount of traffic that is expected to be transmitted and received across multiple served devices, channel conditions of connections between the network entity 105-b and the multiple served devices, or any combinations thereof. In some cases, communications parameters may be determined for each operation mode of a set of two or more operation modes, such as a MCS index, transmit power, TB size, RV index, TB scaling factor, etc. Further, in some cases, a time interval associated with each operation mode may be determined (e.g., a number of frames/slots/symbols associated with each operation mode).

At 510, the network entity 105-b may transmit, and the UE 115-d may receive, configuration information that indicates the two or more operation modes of a set of operation modes. In some cases, the configuration information may be transmitted via RRC signaling, although other types of signaling may be used to convey the configuration information (e.g., a system information block (SIB), downlink control information, medium access control (MAC) control element, or any combinations thereof). In some cases, the configuration information may also include an associated time interval during which the indicated operation mode is to be used.

At 515, the UE 115-d may determine the operation mode for uplink/downlink communications. The operation mode may be a first operation mode, and may be determined based on the configuration information. In some cases, the operation mode may be an initial or regular operation mode that is associated with higher power consumption at the network entity 105-b. At 520, the UE 115-d and the network entity 105-b may exchange uplink/downlink communications according to the first operation mode.

At 525, the network entity 105-b may determine to switch to a second operation mode, which may be a power-saving operation mode. Further, in some cases, the network entity 105-b may determine a time interval associated with the second operation mode (e.g., a time duration, or a number of frames/slots/symbols). At 530, the network entity 105-b may transmit DCI to the UE 115-d that indicates the second operating mode and, if present, an associated time interval. In some cases, the DCI may be a UE-specific DCI that is scrambled with a RNTI associated with the UE 115-d. In some cases, the DCI may be a GC-DCI, and the UE 115-d may be configured with a location in the GC-DCI that provides the indication of the operation mode for an upcoming time interval.

At 535, the UE 115-d may switch to the second operation mode. At 540, the UE 115-d and the network entity 105-b may exchange uplink/downlink communications based on the second operation mode. As discussed herein, the communications may use communications parameters (e.g., MCS, transmit power, TB size, etc.) that are based on the configuration information associated with the second operation mode.

Optionally, at 530, the network entity 105-b may transmit a subsequent DCI that indicates an updated operation mode. For example, the updated operation mode may indicate to revert back to the first operation mode, to maintain the second operation mode, or to switch to a third operation mode that is configured in the set of operation modes. In such cases, at 535, the UE 115-d may determine to switch the operation mode, and at 540 the UE 115-d and network entity 105-b may exchange uplink/downlink communications based on the updated operation mode.

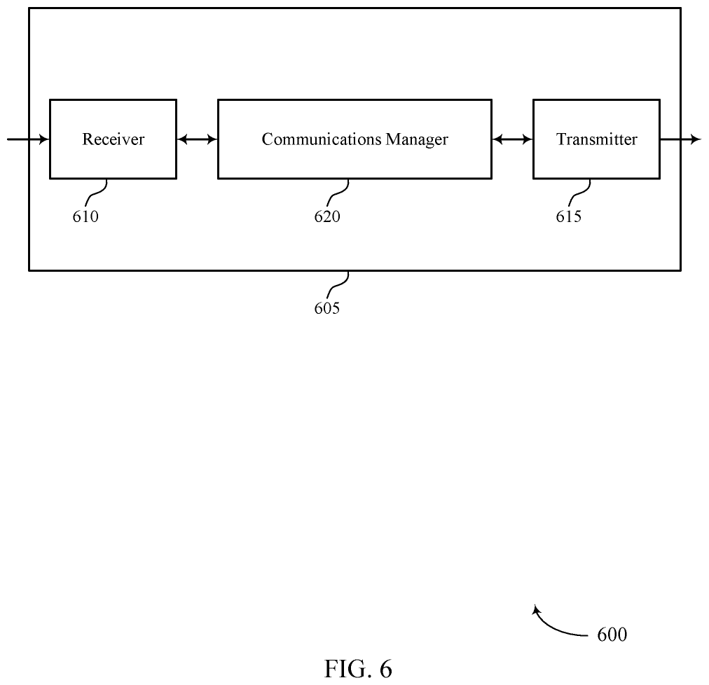

FIG. 6 shows a block diagram 600 of a device 605 that supports techniques for indicating network operation mode in wireless communications in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for indicating network operation mode in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for indicating network operation mode in wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for indicating network operation mode in wireless communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The communications manager 620 may be configured as or otherwise support a means for communicating with the network entity according to the first operation mode using the first set of communications parameters. The communications manager 620 may be configured as or otherwise support a means for receiving control information that indicates the network entity is operating in the second operation mode for a first time interval. The communications manager 620 may be configured as or otherwise support a means for communicating with the network entity according to the second operation mode using the second set of communications parameters for the first time interval associated with the second operation mode.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for enhanced flexibility in selection of operating modes at a network entity, while signaling changes to operation modes in an efficient manner. Such different operation modes at the network entity may provide for reduced power consumption, and described techniques for signaling changes to operation modes may provide flexible and efficient techniques to indicate operation modes to served devices, which may reduce signaling overhead associated with operation mode changes, reduce latency for switching between different operation modes, and enhance overall network efficiency.

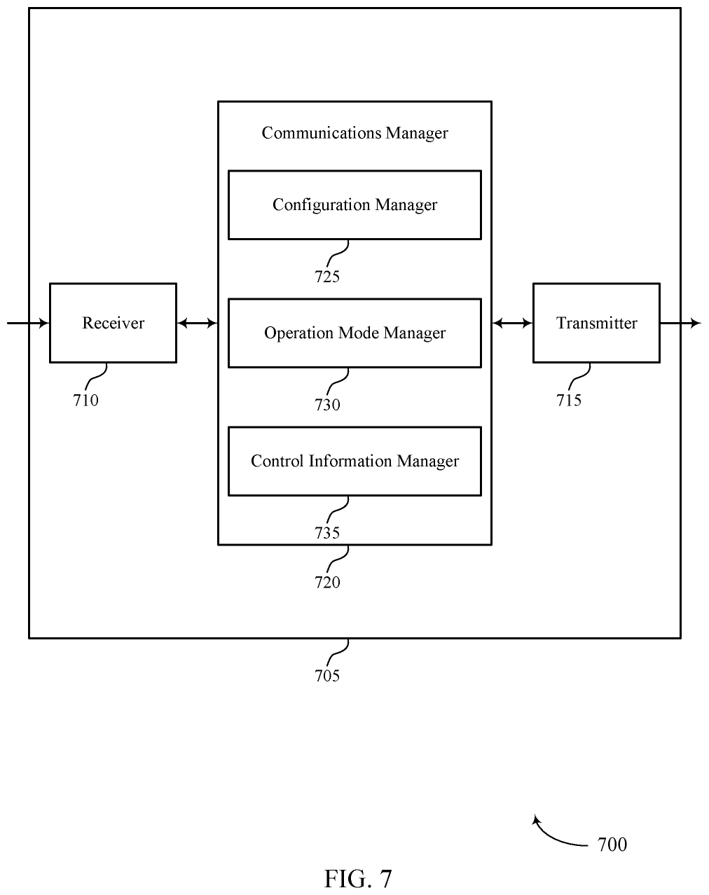

FIG. 7 shows a block diagram 700 of a device 705 that supports techniques for indicating network operation mode in wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for indicating network operation mode in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for indicating network operation mode in wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for indicating network operation mode in wireless communications as described herein. For example, the communications manager 720 may include a configuration manager 725, an operation mode manager 730, a control information manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The configuration manager 725 may be configured as or otherwise support a means for receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The operation mode manager 730 may be configured as or otherwise support a means for communicating with the network entity according to the first operation mode using the first set of communications parameters. The control information manager 735 may be configured as or otherwise support a means for receiving control information that indicates the network entity is operating in the second operation mode for a first time interval. The operation mode manager 730 may be configured as or otherwise support a means for communicating with the network entity according to the second operation mode using the second set of communications parameters for the first time interval associated with the second operation mode.

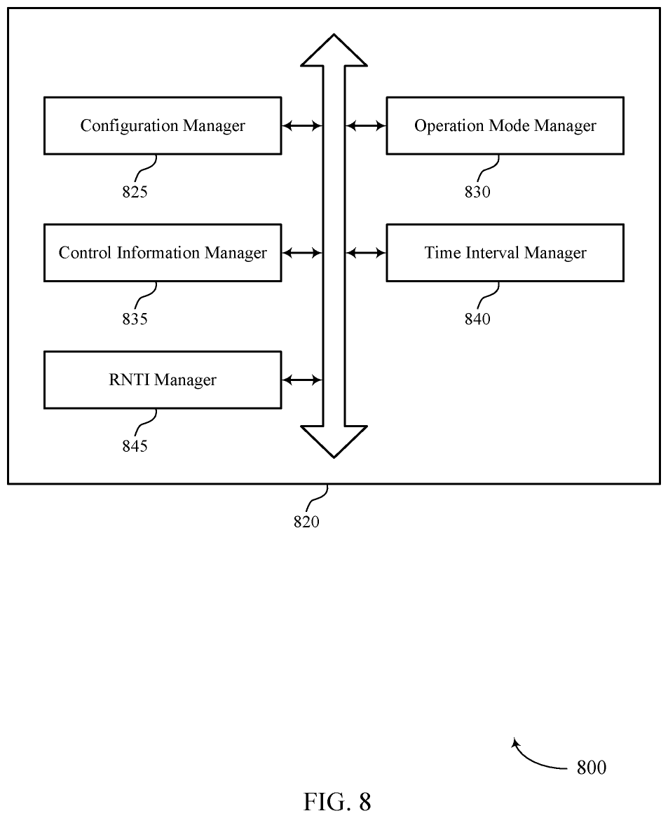

FIG. 8 shows a block diagram 800 of a communications manager 820 that supports techniques for indicating network operation mode in wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for indicating network operation mode in wireless communications as described herein. For example, the communications manager 820 may include a configuration manager 825, an operation mode manager 830, a control information manager 835, a time interval manager 840, an RNTI manager 845, or any combination thereof. Each of these components may communicate, directly or indirectly, with one another (e.g., via one or more buses).

The communications manager 820 may support wireless communication at a UE in accordance with examples as disclosed herein. The configuration manager 825 may be configured as or otherwise support a means for receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The operation mode manager 830 may be configured as or otherwise support a means for communicating with the network entity according to the first operation mode using the first set of communications parameters. The control information manager 835 may be configured as or otherwise support a means for receiving control information that indicates the network entity is operating in the second operation mode for a first time interval. In some examples, the operation mode manager 830 may be configured as or otherwise support a means for communicating with the network entity according to the second operation mode using the second set of communications parameters for the first time interval associated with the second operation mode.

In some examples, to support receiving the set of operation modes, the configuration manager 825 may be configured as or otherwise support a means for receiving RRC signaling that indicates two or more operation modes of the set of operation modes, and that indicates corresponding sets of communications parameters associated with each operation mode of the two or more operation modes, and where different operation modes of the set of operation modes are associated with different energy usage at the network entity. In some examples, the control information indicates the first time interval during which the second operation mode is active. In some examples, the control information is provided in a GC-DCI communication that indicates different operation modes for different UEs that receive the GC-DCI.

In some examples, to support receiving the set of operation modes, the time interval manager 840 may be configured as or otherwise support a means for receiving a timer value associated with each operation mode of the set of operation modes, and where the UE communicates with the network entity according to the first operation mode subsequent to an expiration of a timer that is set based on the timer value associated with the second operation mode. In some examples, the first time interval is indicated in the control information as a selected time interval of a set of available time intervals, or as a number of symbols, slots, or frames associated with the second operation mode. In some examples, the first time interval corresponds to a time duration until a subsequent control information transmission indicates a different operation mode of the set of operation modes. In some examples, the control information manager 835 may be configured as or otherwise support a means for skipping one or more decoding attempts for one or more control information transmissions during the first time interval.

In some examples, the operation mode manager 830 may be configured as or otherwise support a means for communicating with the network entity based on one or more communications parameters associated with a default operation mode when a subsequent control information transmission that indicates a new operation mode is undetected prior to an expiration of the first time interval. In some examples, the configuration manager 825 may be configured as or otherwise support a means for receiving an indication of the default operation mode in RRC signaling. In some examples, the operation mode manager 830 may be configured as or otherwise support a means for communicating with the network entity according to the second operation mode subsequent to an expiration of the first time interval and until a subsequent control information transmission indicates a different operation mode.

In some examples, to support receiving the control information, the control information manager 835 may be configured as or otherwise support a means for receiving a GC-DCI communication that includes two or more different operation mode indications for two or more different UEs. In some examples, to support receiving the control information, the control information manager 835 may be configured as or otherwise support a means for determining which of the two or more different operation mode indications corresponds to the second operation mode based on a location of information in the GC-DCI. In some examples, a network operation field in the GC-DCI indicates a which operation mode of the set of operation modes is to be used for communications, or indicates a sequence of different operation modes for different time intervals. In some examples, the RNTI manager 845 may be configured as or otherwise support a means for receiving a RNTI associated with operation modes that are to be used for communications with the network entity, and where the GC-DCI is received based on the RNTI. In some examples, the operation mode manager 830 may be configured as or otherwise support a means for communicating, with the network entity subsequent to an expiration of the first time interval according to a default operation mode in an absence of a subsequent control information communication that indicates a new operation mode.

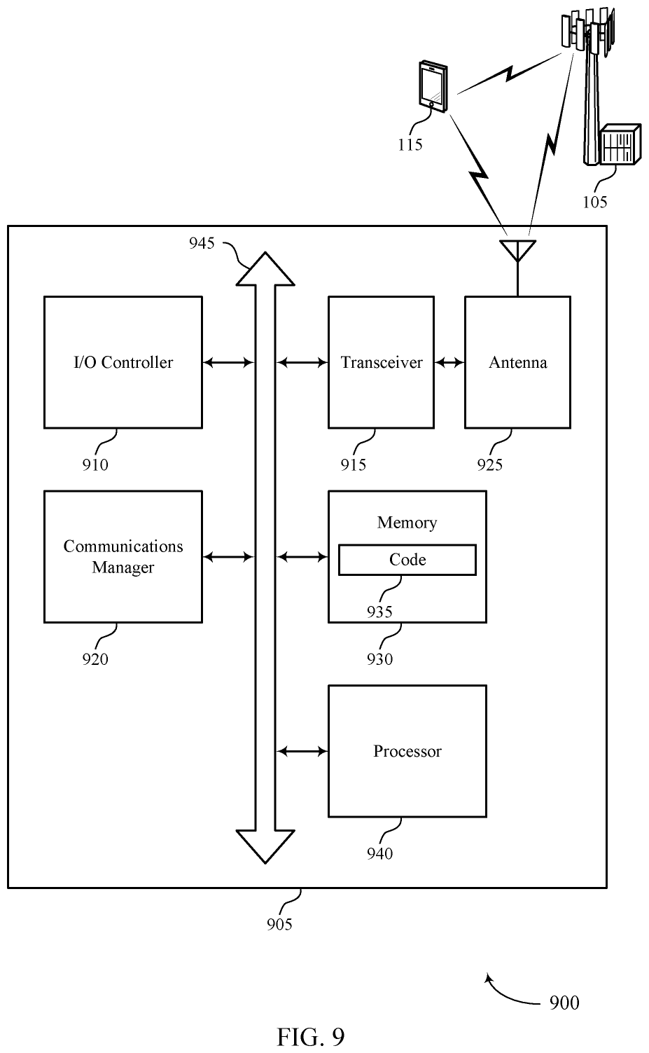

FIG. 9 shows a diagram of a system 900 including a device 905 that supports techniques for indicating network operation mode in wireless communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for indicating network operation mode in wireless communications). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The communications manager 920 may be configured as or otherwise support a means for communicating with the network entity according to the first operation mode using the first set of communications parameters. The communications manager 920 may be configured as or otherwise support a means for receiving control information that indicates the network entity is operating in the second operation mode for a first time interval. The communications manager 920 may be configured as or otherwise support a means for communicating with the network entity according to the second operation mode using the second set of communications parameters for the first time interval associated with the second operation mode.

By including or configuring the communications manager 920 in accordance with examples as described herein, the device 905 may support techniques for enhanced flexibility in selection of operating modes at a network entity, while signaling changes to operation modes in an efficient manner. Such different operation modes at the network entity may provide for reduced power consumption, and described techniques for signaling changes to operation modes may provide flexible and efficient techniques to indicate operation modes to served devices, which may reduce signaling overhead associated with operation mode changes, reduce latency for switching between different operation modes, and enhance overall network efficiency.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for indicating network operation mode in wireless communications as described herein, or the processor 940 and the memory 930 may be otherwise configured to perform or support such operations.

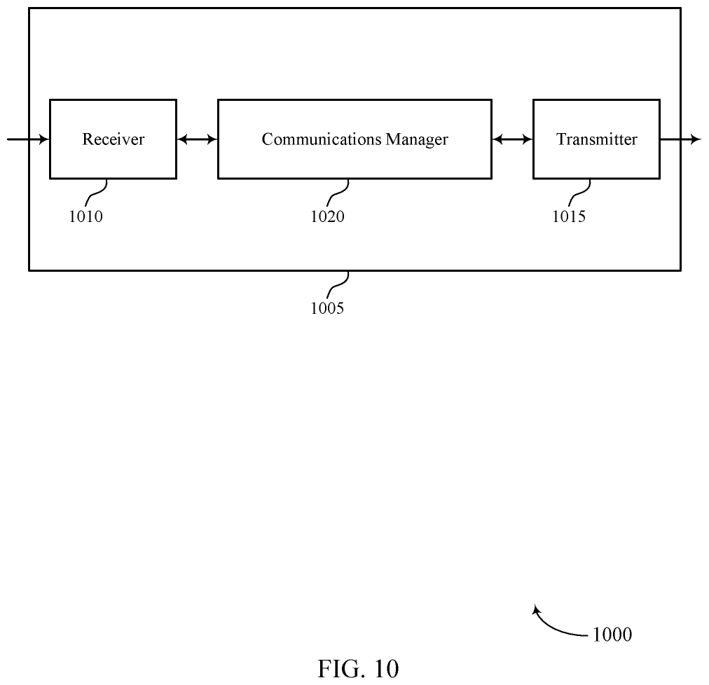

FIG. 10 shows a block diagram 1000 of a device 1005 that supports techniques for indicating network operation mode in wireless communications in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for indicating network operation mode in wireless communications as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The communications manager 1020 may be configured as or otherwise support a means for communicating with the first UE according to the first operation mode using the first set of communications parameters. The communications manager 1020 may be configured as or otherwise support a means for transmitting control information to the first UE that includes an indication to switch to the second operation mode and a first time interval associated with the second operation mode, the indication to switch to the second operation mode based on an energy usage associated with each of the first operation mode and the second operation mode. The communications manager 1020 may be configured as or otherwise support a means for communicating with the first UE according to the second operation mode using the second set of communications parameters for the first time interval associated with the second operation mode.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for enhanced flexibility in selection of operating modes at a network entity, while signaling changes to operation modes in an efficient manner. Such different operation modes at the network entity may provide for reduced power consumption, and described techniques for signaling changes to operation modes may provide flexible and efficient techniques to indicate operation modes to served devices, which may reduce signaling overhead associated with operation mode changes, reduce latency for switching between different operation modes, and enhance overall network efficiency.

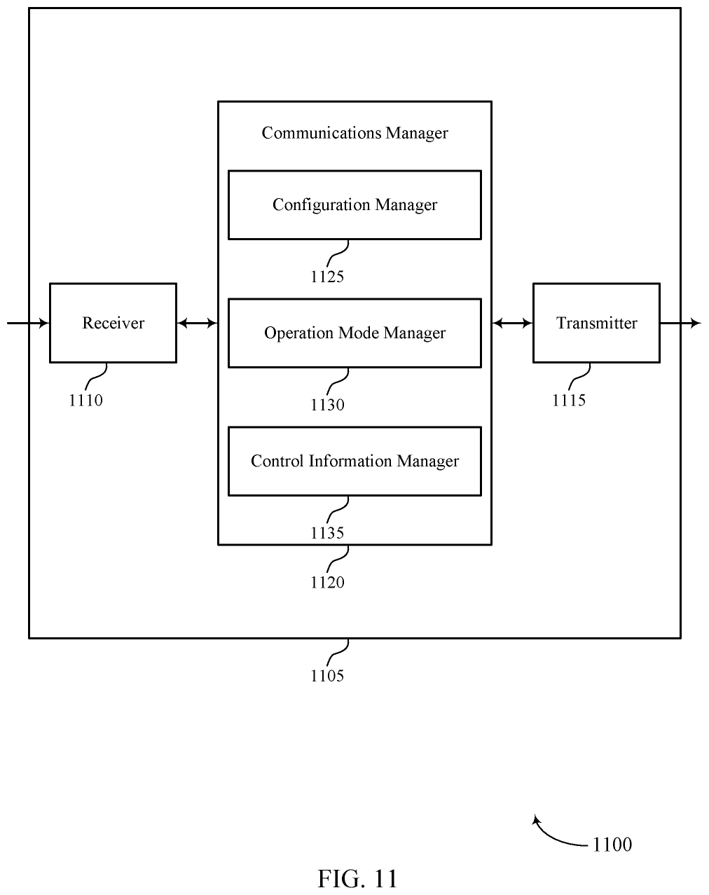

FIG. 11 shows a block diagram 1100 of a device 1105 that supports techniques for indicating network operation mode in wireless communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for indicating network operation mode in wireless communications as described herein. For example, the communications manager 1120 may include a configuration manager 1125, an operation mode manager 1130, a control information manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The configuration manager 1125 may be configured as or otherwise support a means for transmitting, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The operation mode manager 1130 may be configured as or otherwise support a means for communicating with the first UE according to the first operation mode using the first set of communications parameters. The control information manager 1135 may be configured as or otherwise support a means for transmitting control information to the first UE that includes an indication to switch to the second operation mode and a first time interval associated with the second operation mode, the indication to switch to the second operation mode based on an energy usage associated with each of the first operation mode and the second operation mode. The operation mode manager 1130 may be configured as or otherwise support a means for communicating with the first UE according to the second operation mode using the second set of communications parameters for the first time interval associated with the second operation mode.

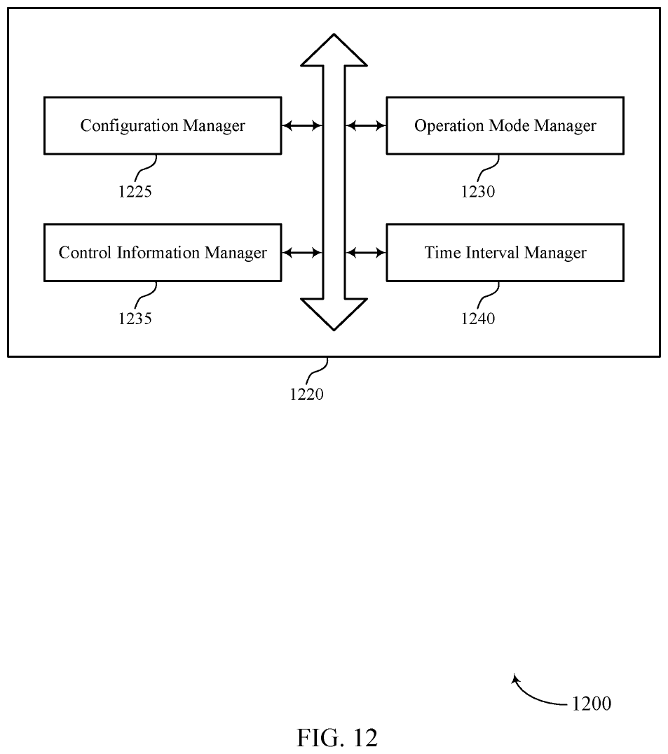

FIG. 12 shows a block diagram 1200 of a communications manager 1220 that supports techniques for indicating network operation mode in wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for indicating network operation mode in wireless communications as described herein. For example, the communications manager 1220 may include a configuration manager 1225, an operation mode manager 1230, a control information manager 1235, a time interval manager 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The configuration manager 1225 may be configured as or otherwise support a means for transmitting, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The operation mode manager 1230 may be configured as or otherwise support a means for communicating with the first UE according to the first operation mode using the first set of communications parameters. The control information manager 1235 may be configured as or otherwise support a means for transmitting control information to the first UE that includes an indication to switch to the second operation mode and a first time interval associated with the second operation mode, the indication to switch to the second operation mode based on an energy usage associated with each of the first operation mode and the second operation mode. In some examples, the operation mode manager 1230 may be configured as or otherwise support a means for communicating with the first UE according to the second operation mode using the second set of communications parameters for the first time interval associated with the second operation mode.

In some examples, to support transmitting the set of operation modes, the configuration manager 1225 may be configured as or otherwise support a means for transmitting RRC signaling that indicates two or more operation modes of the set of operation modes, and that indicates corresponding sets of communications parameters associated with each operation mode of the two or more operation modes, and where different operation modes of the set of operation modes are associated with different energy usage. In some examples, the control information indicates the first time interval during which the second operation mode is active. In some examples, the control information is provided in a GC-DCI communication that indicates different operation modes for different UEs that receive the GC-DCI.

In some examples, to support transmitting the set of operation modes, the time interval manager 1240 may be configured as or otherwise support a means for transmitting a timer value associated with each operation mode of the set of operation modes, and where the first UE communicates with the network entity according to the first operation mode subsequent to an expiration of a timer that is set based on the timer value associated with the second operation mode. In some examples, the first time interval is indicated in the control information as a selected time interval of a set of available time intervals, or as a number of symbols, slots, or frames associated with the second operation mode.

In some examples, the operation mode manager 1230 may be configured as or otherwise support a means for communicating with the first UE based on one or more communications parameters associated with a default operation mode when a subsequent control information transmission that indicates a new operation mode is not transmitted prior to an expiration of the first time interval. In some examples, the configuration manager 1225 may be configured as or otherwise support a means for transmitting an indication of the default operation mode in RRC signaling. In some examples, to support transmitting the control information, the control information manager 1235 may be configured as or otherwise support a means for transmitting a GC-DCI communication that includes two or more different operation mode indications for at least the first UE and a second UE, and where different locations in the GC-DCI are associated with the first UE and the second UE and the operation mode for each UE is provided in a corresponding location in the GC-DCI.

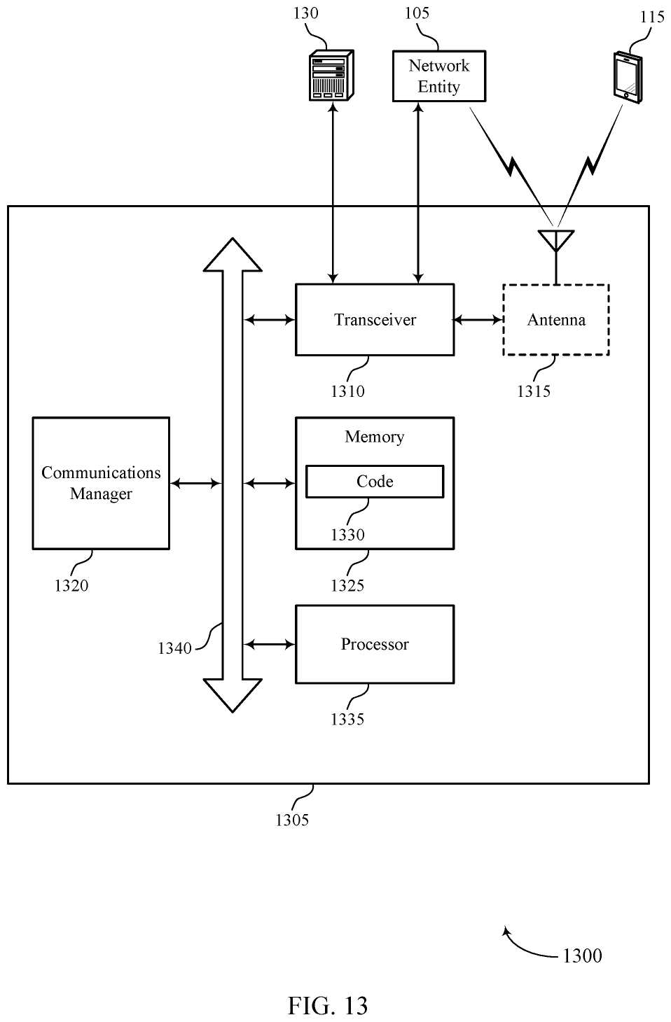

FIG. 13 shows a diagram of a system 1300 including a device 1305 that supports techniques for indicating network operation mode in wireless communications in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for indicating network operation mode in wireless communications). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The communications manager 1320 may be configured as or otherwise support a means for communicating with the first UE according to the first operation mode using the first set of communications parameters. The communications manager 1320 may be configured as or otherwise support a means for transmitting control information to the first UE that includes an indication to switch to the second operation mode and a first time interval associated with the second operation mode, the indication to switch to the second operation mode based on an energy usage associated with each of the first operation mode and the second operation mode. The communications manager 1320 may be configured as or otherwise support a means for communicating with the first UE according to the second operation mode using the second set of communications parameters for the first time interval associated with the second operation mode.

By including or configuring the communications manager 1320 in accordance with examples as described herein, the device 1305 may support techniques for enhanced flexibility in selection of operating modes at a network entity, while signaling changes to operation modes in an efficient manner. Such different operation modes at the network entity may provide for reduced power consumption, and described techniques for signaling changes to operation modes may provide flexible and efficient techniques to indicate operation modes to served devices, which may reduce signaling overhead associated with operation mode changes, reduce latency for switching between different operation modes, and enhance overall network efficiency.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for indicating network operation mode in wireless communications as described herein, or the processor 1335 and the memory 1325 may be otherwise configured to perform or support such operations.

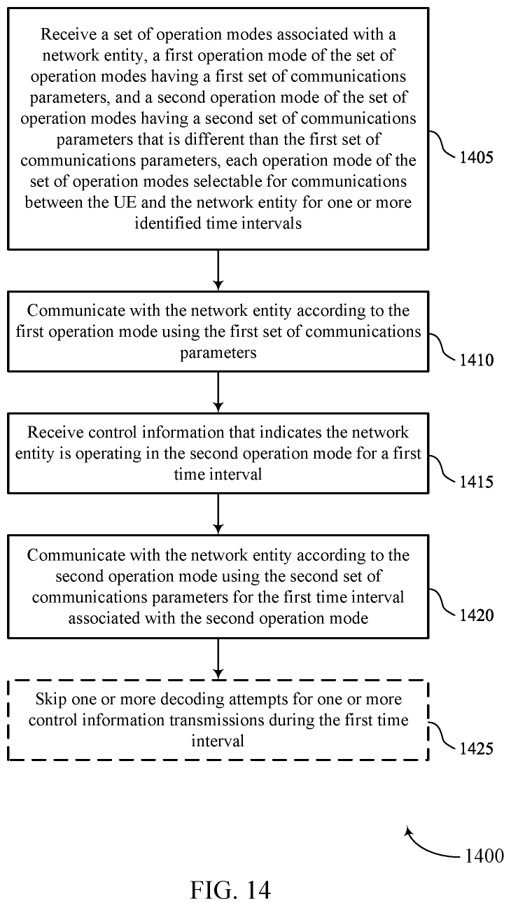

FIG. 14 shows a flowchart illustrating a method 1400 that supports techniques for indicating network operation mode in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The operations of 1405 may be performed in accordance with examples as disclosed herein. In some examples, aspects of the operations of 1405 may be performed by a configuration manager 825 as described with reference to FIG. 8.

At 1410, the method may include communicating with the network entity according to the first operation mode using the first set of communications parameters. The operations of 1410 may be performed in accordance with examples as disclosed herein. In some examples, aspects of the operations of 1410 may be performed by an operation mode manager 830 as described with reference to FIG. 8.

At 1415, the method may include receiving control information that indicates the network entity is operating in the second operation mode for a first time interval. The operations of 1415 may be performed in accordance with examples as disclosed herein. In some examples, aspects of the operations of 1415 may be performed by a control information manager 835 as described with reference to FIG. 8.

At 1420, the method may include communicating with the network entity according to the second operation mode using the second set of communications parameters for the first time interval associated with the second operation mode. The operations of 1420 may be performed in accordance with examples as disclosed herein. In some examples, aspects of the operations of 1420 may be performed by an operation mode manager 830 as described with reference to FIG. 8.

Optionally, at 1425, the method may include skipping one or more decoding attempts for one or more control information transmissions during the first time interval. The operations of 1425 may be performed in accordance with examples as disclosed herein. In some examples, aspects of the operations of 1425 may be performed by a control information manager 835 as described with reference to FIG. 8.

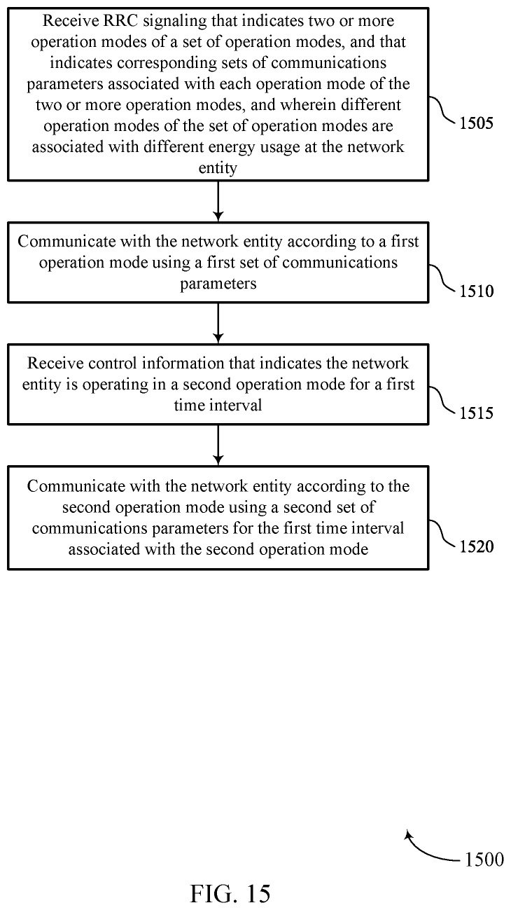

FIG. 15 shows a flowchart illustrating a method 1500 that supports techniques for indicating network operation mode in wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving RRC signaling that indicates two or more operation modes of a set of operation modes, and that indicates corresponding sets of communications parameters associated with each operation mode of the two or more operation modes, and where different operation modes of the set of operation modes are associated with different energy usage at the network entity. The operations of 1505 may be performed in accordance with examples as disclosed herein. In some examples, aspects of the operations of 1505 may be performed by a configuration manager 825 as described with reference to FIG. 8.

At 1510, the method may include communicating with the network entity according to a first operation mode using a first set of communications parameters. The operations of 1510 may be performed in accordance with examples as disclosed herein. In some examples, aspects of the operations of 1510 may be performed by an operation mode manager 830 as described with reference to FIG. 8.

At 1515, the method may include receiving control information that indicates the network entity is operating in a second operation mode for a first time interval. The operations of 1515 may be performed in accordance with examples as disclosed herein. In some examples, aspects of the operations of 1515 may be performed by a control information manager 835 as described with reference to FIG. 8.

At 1520, the method may include communicating with the network entity according to the second operation mode using a second set of communications parameters for the first time interval associated with the second operation mode. The operations of 1520 may be performed in accordance with examples as disclosed herein. In some examples, aspects of the operations of 1520 may be performed by an operation mode manager 830 as described with reference to FIG. 8.

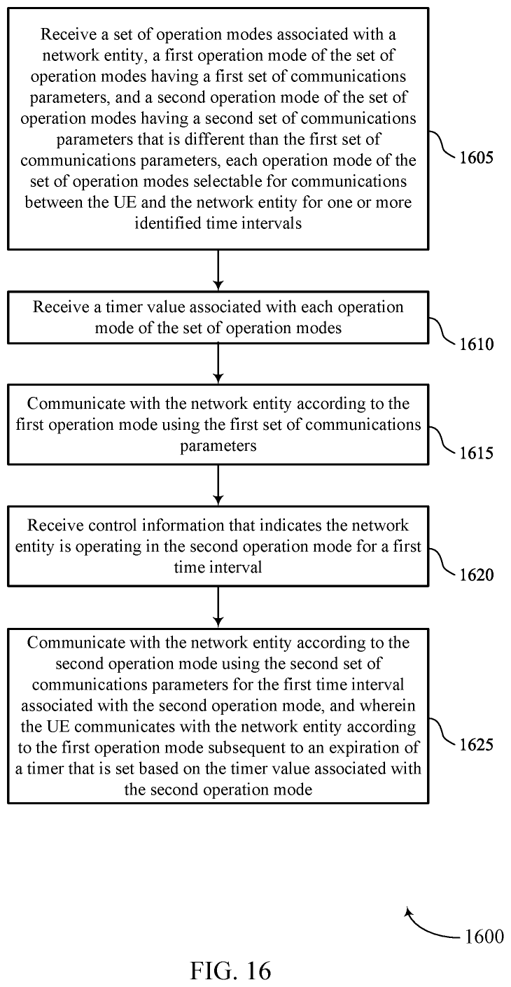

FIG. 16 shows a flowchart illustrating a method 1600 that supports techniques for indicating network operation mode in wireless communications in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The operations of 1605 may be performed in accordance with examples as disclosed herein. In some examples, aspects of the operations of 1605 may be performed by a configuration manager 825 as described with reference to FIG. 8.

At 1610, the method may include receiving a timer value associated with each operation mode of the set of operation modes. The operations of 1610 may be performed in accordance with examples as disclosed herein. In some examples, aspects of the operations of 1610 may be performed by a time interval manager 840 as described with reference to FIG. 8.

At 1615, the method may include communicating with the network entity according to the first operation mode using the first set of communications parameters. The operations of 1615 may be performed in accordance with examples as disclosed herein. In some examples, aspects of the operations of 1615 may be performed by an operation mode manager 830 as described with reference to FIG. 8.

At 1620, the method may include receiving control information that indicates the network entity is operating in the second operation mode for a first time interval. The operations of 1620 may be performed in accordance with examples as disclosed herein. In some examples, aspects of the operations of 1620 may be performed by a control information manager 835 as described with reference to FIG. 8.

At 1625, the method may include communicating with the network entity according to the second operation mode using the second set of communications parameters for the first time interval associated with the second operation mode, and where the UE communicates with the network entity according to the first operation mode subsequent to an expiration of a timer that is set based on the timer value associated with the second operation mode. The operations of 1625 may be performed in accordance with examples as disclosed herein. In some examples, aspects of the operations of 1625 may be performed by an operation mode manager 830 as described with reference to FIG. 8.

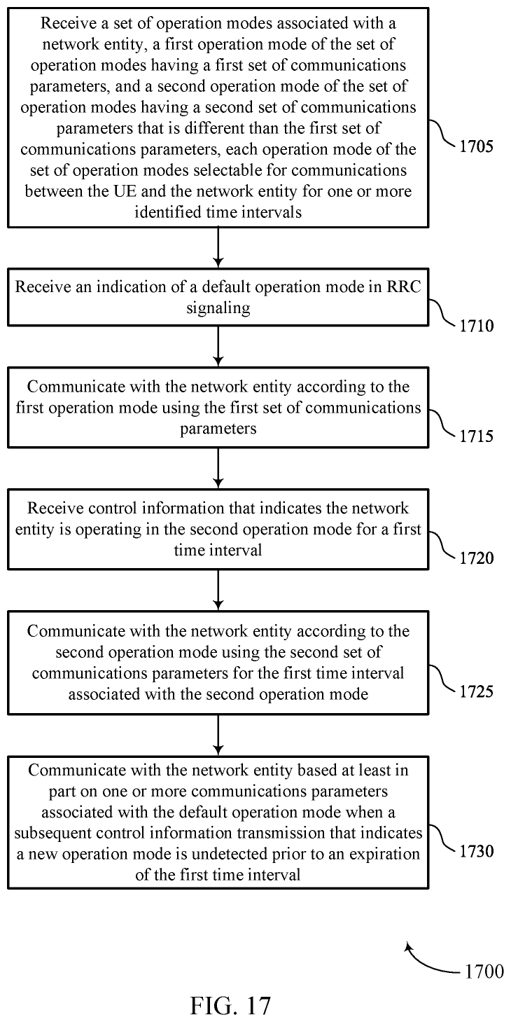

FIG. 17 shows a flowchart illustrating a method 1700 that supports techniques for indicating network operation mode in wireless communications in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The operations of 1705 may be performed in accordance with examples as disclosed herein. In some examples, aspects of the operations of 1705 may be performed by a configuration manager 825 as described with reference to FIG. 8.

At 1710, the method may include receiving an indication of a default operation mode in RRC signaling. The operations of 1710 may be performed in accordance with examples as disclosed herein. In some examples, aspects of the operations of 1710 may be performed by a configuration manager 825 as described with reference to FIG. 8.

At 1715, the method may include communicating with the network entity according to the first operation mode using the first set of communications parameters. The operations of 1715 may be performed in accordance with examples as disclosed herein. In some examples, aspects of the operations of 1715 may be performed by an operation mode manager 830 as described with reference to FIG. 8.

At 1720, the method may include receiving control information that indicates the network entity is operating in the second operation mode for a first time interval. The operations of 1720 may be performed in accordance with examples as disclosed herein. In some examples, aspects of the operations of 1720 may be performed by a control information manager 835 as described with reference to FIG. 8.

At 1725, the method may include communicating with the network entity according to the second operation mode using the second set of communications parameters for the first time interval associated with the second operation mode. The operations of 1725 may be performed in accordance with examples as disclosed herein. In some examples, aspects of the operations of 1725 may be performed by an operation mode manager 830 as described with reference to FIG. 8.

At 1730, the method may include communicating with the network entity based on one or more communications parameters associated with the default operation mode when a subsequent control information transmission that indicates a new operation mode is undetected prior to an expiration of the first time interval. The operations of 1730 may be performed in accordance with examples as disclosed herein. In some examples, aspects of the operations of 1730 may be performed by an operation mode manager 830 as described with reference to FIG. 8.

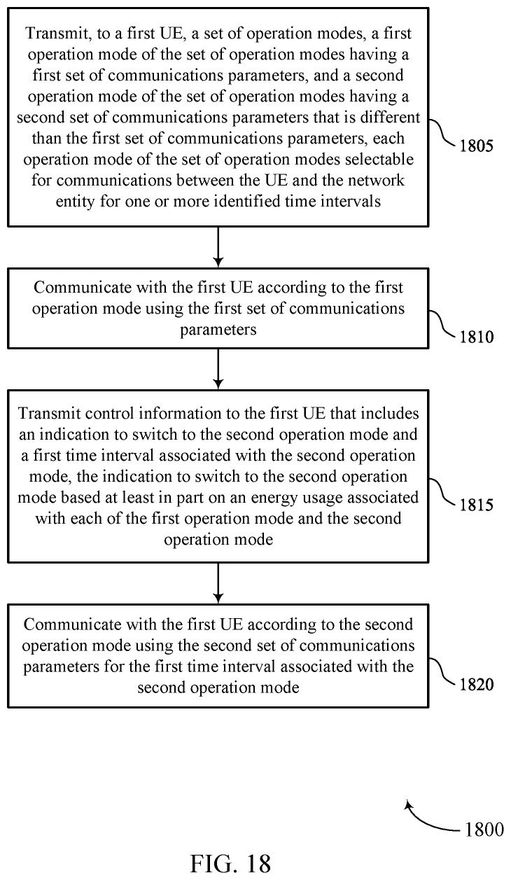

FIG. 18 shows a flowchart illustrating a method 1800 that supports techniques for indicating network operation mode in wireless communications in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The operations of 1805 may be performed in accordance with examples as disclosed herein. In some examples, aspects of the operations of 1805 may be performed by a configuration manager 1225 as described with reference to FIG. 12.

At 1810, the method may include communicating with the first UE according to the first operation mode using the first set of communications parameters. The operations of 1810 may be performed in accordance with examples as disclosed herein. In some examples, aspects of the operations of 1810 may be performed by an operation mode manager 1230 as described with reference to FIG. 12.

At 1815, the method may include transmitting control information to the first UE that includes an indication to switch to the second operation mode and a first time interval associated with the second operation mode, the indication to switch to the second operation mode based on an energy usage associated with each of the first operation mode and the second operation mode. The operations of 1815 may be performed in accordance with examples as disclosed herein. In some examples, aspects of the operations of 1815 may be performed by a control information manager 1235 as described with reference to FIG. 12.

At 1820, the method may include communicating with the first UE according to the second operation mode using the second set of communications parameters for the first time interval associated with the second operation mode. The operations of 1820 may be performed in accordance with examples as disclosed herein. In some examples, aspects of the operations of 1820 may be performed by an operation mode manager 1230 as described with reference to FIG. 12.

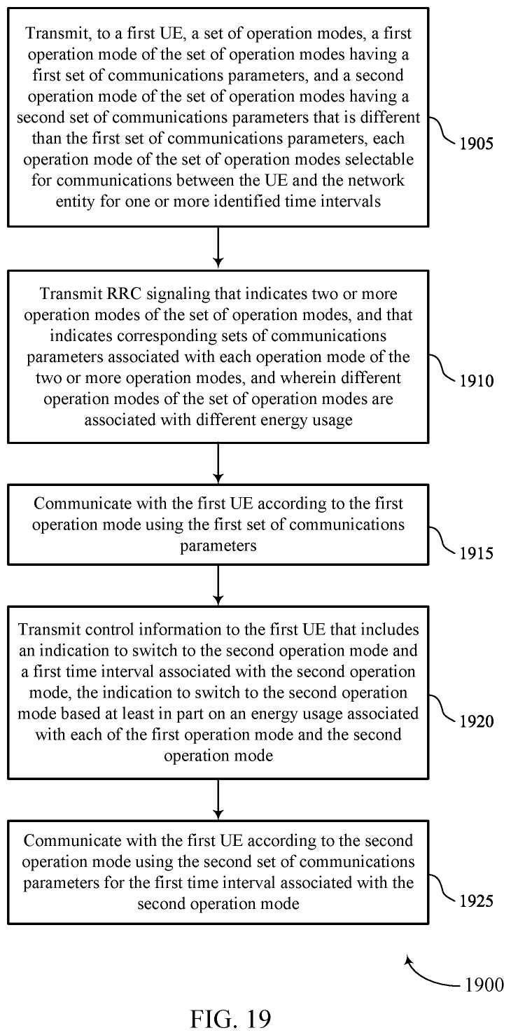

FIG. 19 shows a flowchart illustrating a method 1900 that supports techniques for indicating network operation mode in wireless communications in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The operations of 1905 may be performed in accordance with examples as disclosed herein. In some examples, aspects of the operations of 1905 may be performed by a configuration manager 1225 as described with reference to FIG. 12.

At 1910, the method may include transmitting RRC signaling that indicates two or more operation modes of the set of operation modes, and that indicates corresponding sets of communications parameters associated with each operation mode of the two or more operation modes, and where different operation modes of the set of operation modes are associated with different energy usage. The operations of 1910 may be performed in accordance with examples as disclosed herein. In some examples, aspects of the operations of 1910 may be performed by a configuration manager 1225 as described with reference to FIG. 12.

At 1915, the method may include communicating with the first UE according to the first operation mode using the first set of communications parameters. The operations of 1915 may be performed in accordance with examples as disclosed herein. In some examples, aspects of the operations of 1915 may be performed by an operation mode manager 1230 as described with reference to FIG. 12.

At 1920, the method may include transmitting control information to the first UE that includes an indication to switch to the second operation mode and a first time interval associated with the second operation mode, the indication to switch to the second operation mode based on an energy usage associated with each of the first operation mode and the second operation mode. The operations of 1920 may be performed in accordance with examples as disclosed herein. In some examples, aspects of the operations of 1920 may be performed by a control information manager 1235 as described with reference to FIG. 12.

At 1925, the method may include communicating with the first UE according to the second operation mode using the second set of communications parameters for the first time interval associated with the second operation mode. The operations of 1925 may be performed in accordance with examples as disclosed herein. In some examples, aspects of the operations of 1925 may be performed by an operation mode manager 1230 as described with reference to FIG. 12.

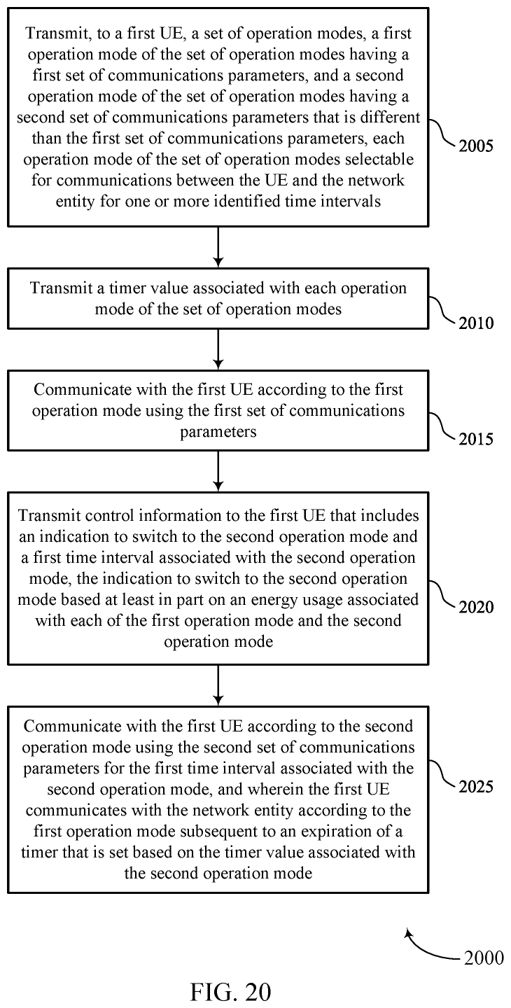

FIG. 20 shows a flowchart illustrating a method 2000 that supports techniques for indicating network operation mode in wireless communications in accordance with one or more aspects of the present disclosure. The operations of the method 2000 may be implemented by a network entity or its components as described herein. For example, the operations of the method 2000 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2005, the method may include transmitting, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals. The operations of 2005 may be performed in accordance with examples as disclosed herein. In some examples, aspects of the operations of 2005 may be performed by a configuration manager 1225 as described with reference to FIG. 12.

At 2010, the method may include transmitting a timer value associated with each operation mode of the set of operation modes. The operations of 2010 may be performed in accordance with examples as disclosed herein. In some examples, aspects of the operations of 2010 may be performed by a time interval manager 1240 as described with reference to FIG. 12.

At 2015, the method may include communicating with the first UE according to the first operation mode using the first set of communications parameters. The operations of 2015 may be performed in accordance with examples as disclosed herein. In some examples, aspects of the operations of 2015 may be performed by an operation mode manager 1230 as described with reference to FIG. 12.

At 2020, the method may include transmitting control information to the first UE that includes an indication to switch to the second operation mode and a first time interval associated with the second operation mode, the indication to switch to the second operation mode based on an energy usage associated with each of the first operation mode and the second operation mode. The operations of 2020 may be performed in accordance with examples as disclosed herein. In some examples, aspects of the operations of 2020 may be performed by a control information manager 1235 as described with reference to FIG. 12.

At 2025, the method may include communicating with the first UE according to the second operation mode using the second set of communications parameters for the first time interval associated with the second operation mode, and where the first UE communicates with the network entity according to the first operation mode subsequent to an expiration of a timer that is set based on the timer value associated with the second operation mode. The operations of 2025 may be performed in accordance with examples as disclosed herein. In some examples, aspects of the operations of 2025 may be performed by an operation mode manager 1230 as described with reference to FIG. 12.

The following provides an overview of aspects of the present disclosure:

Aspect 1: A method for wireless communication at a UE, comprising: receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals; communicating with the network entity according to the first operation mode using the first set of communications parameters; receiving control information that indicates the network entity is operating in the second operation mode for a first time interval; and communicating with the network entity according to the second operation mode using the second set of communications parameters for the first time interval associated with the second operation mode.

Aspect 2: The method of aspect 1, wherein the receiving the set of operation modes comprises: receiving RRC signaling that indicates two or more operation modes of the set of operation modes, and that indicates corresponding sets of communications parameters associated with each operation mode of the two or more operation modes, and wherein different operation modes of the set of operation modes are associated with different energy usage at the network entity.

Aspect 3: The method of any of aspects 1 through 2, wherein the control information indicates the first time interval during which the second operation mode is active.

Aspect 4: The method of any of aspects 1 through 3, wherein the control information is provided in a group-common downlink control information (GC-DCI) communication that indicates different operation modes for different UEs that receive the GC-DCI.

Aspect 5: The method of any of aspects 1 through 4, wherein the receiving the set of operation modes further comprises: receiving a timer value associated with each operation mode of the set of operation modes, and wherein the UE communicates with the network entity according to the first operation mode subsequent to an expiration of a timer that is set based on the timer value associated with the second operation mode.

Aspect 6: The method of any of aspects 1 through 5, wherein the first time interval is indicated in the control information as a selected time interval of a set of available time intervals, or as a number of symbols, slots, or frames associated with the second operation mode.

Aspect 7: The method of any of aspects 1 through 6, wherein the first time interval corresponds to a time duration until a subsequent control information transmission indicates a different operation mode of the set of operation modes.

Aspect 8: The method of any of aspects 1 through 7, further comprising: skipping one or more decoding attempts for one or more control information transmissions during the first time interval.

Aspect 9: The method of any of aspects 1 through 8, further comprising: communicating with the network entity based at least in part on one or more communications parameters associated with a default operation mode when a subsequent control information transmission that indicates a new operation mode is undetected prior to an expiration of the first time interval.

Aspect 10: The method of aspect 9, further comprising: receiving an indication of the default operation mode in RRC signaling.

Aspect 11: The method of any of aspects 1 through 8, further comprising: communicating with the network entity according to the second operation mode subsequent to an expiration of the first time interval and until a subsequent control information transmission indicates a different operation mode.

Aspect 12: The method of any of aspects 1 through 11, wherein the receiving the control information comprises: receiving a group-common downlink control information (GC-DCI) communication that includes two or more different operation mode indications for two or more different UEs; and determining which of the two or more different operation mode indications corresponds to the second operation mode based at least in part on a location of information in the GC-DCI.

Aspect 13: The method of aspect 12, wherein a network operation field in the GC-DCI indicates a which operation mode of the set of operation modes is to be used for communications, or indicates a sequence of different operation modes for different time intervals.

Aspect 14: The method of any of aspects 12 through 13, further comprising: receiving a radio network temporary identifier (RNTI) associated with operation modes that are to be used for communications with the network entity, and wherein the GC-DCI is received based at least in part on the RNTI.

Aspect 15: The method of any of aspects 1 through 14, further comprising: communicating, with the network entity subsequent to an expiration of the first time interval according to a default operation mode in an absence of a subsequent control information communication that indicates a new operation mode.

Aspect 16: A method for wireless communication at a network entity, comprising: transmitting, to a first UE, a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals; communicating with the first UE according to the first operation mode using the first set of communications parameters; transmitting control information to the first UE that includes an indication to switch to the second operation mode and a first time interval associated with the second operation mode, the indication to switch to the second operation mode based at least in part on an energy usage associated with each of the first operation mode and the second operation mode; and communicating with the first UE according to the second operation mode using the second set of communications parameters for the first time interval associated with the second operation mode.

Aspect 17: The method of aspect 16, wherein the transmitting the set of operation modes comprises: transmitting RRC signaling that indicates two or more operation modes of the set of operation modes, and that indicates corresponding sets of communications parameters associated with each operation mode of the two or more operation modes, and wherein different operation modes of the set of operation modes are associated with different energy usage.

Aspect 18: The method of any of aspects 16 through 17, wherein the control information indicates the first time interval during which the second operation mode is active.

Aspect 19: The method of any of aspects 16 through 18, wherein the control information is provided in a group-common downlink control information (GC-DCI) communication that indicates different operation modes for different UEs that receive the GC-DCI.

Aspect 20: The method of any of aspects 16 through 19, wherein the transmitting the set of operation modes further comprises: transmitting a timer value associated with each operation mode of the set of operation modes, and wherein the first UE communicates with the network entity according to the first operation mode subsequent to an expiration of a timer that is set based on the timer value associated with the second operation mode.

Aspect 21: The method of any of aspects 16 through 20, wherein the first time interval is indicated in the control information as a selected time interval of a set of available time intervals, or as a number of symbols, slots, or frames associated with the second operation mode.

Aspect 22: The method of any of aspects 16 through 21, further comprising: communicating with the first UE based at least in part on one or more communications parameters associated with a default operation mode when a subsequent control information transmission that indicates a new operation mode is not transmitted prior to an expiration of the first time interval.

Aspect 23: The method of aspect 22, further comprising: transmitting an indication of the default operation mode in RRC signaling.

Aspect 24: The method of any of aspects 16 through 23, wherein the transmitting the control information comprises: transmitting a group-common downlink control information (GC-DCI) communication that includes two or more different operation mode indications for at least the first UE and a second UE, and wherein different locations in the GC-DCI are associated with the first UE and the second UE and the operation mode for each UE is provided in a corresponding location in the GC-DCI.

Aspect 25: An apparatus for wireless communication at a UE, comprising a processor; memory coupled with the processor; and instructions stored in the memory and executable by the processor to cause the apparatus to perform a method of any of aspects 1 through 15.

Aspect 26: An apparatus for wireless communication at a UE, comprising at least one means for performing a method of any of aspects 1 through 15.

Aspect 27: A non-transitory computer-readable medium storing code for wireless communication at a UE, the code comprising instructions executable by a processor to perform a method of any of aspects 1 through 15.

Aspect 28: An apparatus for wireless communication at a network entity, comprising a processor; memory coupled with the processor; and instructions stored in the memory and executable by the processor to cause the apparatus to perform a method of any of aspects 16 through 24.

Aspect 29: An apparatus for wireless communication at a network entity, comprising at least one means for performing a method of any of aspects 16 through 24.

Aspect 30: A non-transitory computer-readable medium storing code for wireless communication at a network entity, the code comprising instructions executable by a processor to perform a method of any of aspects 16 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals;
communicating with the network entity according to the first operation mode using the first set of communications parameters;
receiving control information that indicates the network entity is operating in the second operation mode for a first time interval; and
communicating with the network entity according to the second operation mode using the second set of communications parameters for the first time interval associated with the second operation mode.

2. The method of claim 1, wherein the receiving the set of operation modes comprises:
receiving radio resource control (RRC) signaling that indicates two or more operation modes of the set of operation modes, and that indicates corresponding sets of communications parameters associated with each operation mode of the two or more operation modes, and wherein different operation modes of the set of operation modes are associated with different energy usage at the network entity.

3. The method of claim 1, wherein the control information indicates the first time interval during which the second operation mode is active.

4. The method of claim 1, wherein the control information is provided in a group-common downlink control information (GC-DCI) communication that indicates different operation modes for different UEs that receive the GC-DCI.

5. The method of claim 1, wherein the receiving the set of operation modes further comprises:
receiving a timer value associated with each operation mode of the set of operation modes, and wherein the UE communicates with the network entity according to the first operation mode subsequent to an expiration of a timer that is set based on the timer value associated with the second operation mode.

6. The method of claim 1, wherein the first time interval is indicated in the control information as a selected time interval of a set of available time intervals, or as a number of symbols, slots, or frames associated with the second operation mode.

7. The method of claim 1, wherein the first time interval corresponds to a time duration until a subsequent control information transmission indicates a different operation mode of the set of operation modes.

8. The method of claim 1, further comprising:
skipping one or more decoding attempts for one or more control information transmissions during the first time interval.

9. The method of claim 1, further comprising:
communicating with the network entity based at least in part on one or more communications parameters associated with a default operation mode when a subsequent control information transmission that indicates a new operation mode is undetected prior to an expiration of the first time interval.

10. The method of claim 9, further comprising:
receiving an indication of the default operation mode in radio resource control (RRC) signaling.

11. The method of claim 1, further comprising:
communicating with the network entity according to the second operation mode subsequent to an expiration of the first time interval and until a subsequent control information transmission indicates a different operation mode.

12. The method of claim 1, wherein the receiving the control information comprises:
receiving a group-common downlink control information (GC-DCI) communication that includes two or more different operation mode indications for two or more different UEs; and
determining which of the two or more different operation mode indications corresponds to the second operation mode based at least in part on a location of information in the GC-DCI.

13. The method of claim 12, wherein a network operation field in the GC-DCI indicates a which operation mode of the set of operation modes is to be used for communications, or indicates a sequence of different operation modes for different time intervals.

14. The method of claim 12, further comprising:
receiving a radio network temporary identifier (RNTI) associated with operation modes that are to be used for communications with the network entity, and wherein the GC-DCI is received based at least in part on the RNTI.

15. The method of claim 1, further comprising:
communicating, with the network entity subsequent to an expiration of the first time interval according to a default operation mode in an absence of a subsequent control information communication that indicates a new operation mode.

16. A method for wireless communication at a network entity, comprising:
transmitting, to a first user equipment (UE), a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals;
communicating with the first UE according to the first operation mode using the first set of communications parameters;
transmitting control information to the first UE that includes an indication to switch to the second operation mode and a first time interval associated with the second operation mode, the indication to switch to the second operation mode based at least in part on an energy usage associated with each of the first operation mode and the second operation mode; and
communicating with the first UE according to the second operation mode using the second set of communications parameters for the first time interval associated with the second operation mode.

17. The method of claim 16, wherein the transmitting the set of operation modes comprises:
transmitting radio resource control (RRC) signaling that indicates two or more operation modes of the set of operation modes, and that indicates corresponding sets of communications parameters associated with each operation mode of the two or more operation modes, and wherein different operation modes of the set of operation modes are associated with different energy usage.

18. The method of claim 16, wherein the control information indicates the first time interval during which the second operation mode is active.

19. The method of claim 16, wherein the control information is provided in a group-common downlink control information (GC-DCI) communication that indicates different operation modes for different UEs that receive the GC-DCI.

20. The method of claim 16, wherein the transmitting the set of operation modes further comprises:
transmitting a timer value associated with each operation mode of the set of operation modes, and wherein the first UE communicates with the network entity according to the first operation mode subsequent to an expiration of a timer that is set based on the timer value associated with the second operation mode.

21. The method of claim 16, wherein the first time interval is indicated in the control information as a selected time interval of a set of available time intervals, or as a number of symbols, slots, or frames associated with the second operation mode.

22. The method of claim 16, further comprising:
communicating with the first UE based at least in part on one or more communications parameters associated with a default operation mode when a subsequent control information transmission that indicates a new operation mode is not transmitted prior to an expiration of the first time interval.

23. The method of claim 22, further comprising:
transmitting an indication of the default operation mode in radio resource control (RRC) signaling.

24. The method of claim 16, wherein the transmitting the control information comprises:
transmitting a group-common downlink control information (GC-DCI) communication that includes two or more different operation mode indications for at least the first UE and a second UE, and wherein different locations in the GC-DCI are associated with the first UE and the second UE and the operation mode for each UE is provided in a corresponding location in the GC-DCI.

25. An apparatus for wireless communication at a user equipment (UE), comprising:
a processor;
memory coupled with the processor; and
instructions stored in the memory and executable by the processor to cause the apparatus to:
receive a set of operation modes associated with a network entity, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals;
communicate with the network entity according to the first operation mode using the first set of communications parameters;
receive control information that indicates the network entity is operating in the second operation mode for a first time interval; and
communicate with the network entity according to the second operation mode using the second set of communications parameters for the first time interval associated with the second operation mode.

26. The apparatus of claim 25, wherein the instructions to receive the set of operation modes are executable by the processor to cause the apparatus to:
receive radio resource control (RRC) signaling that indicates two or more operation modes of the set of operation modes, and that indicates corresponding sets of communications parameters associated with each operation mode of the two or more operation modes, and wherein different operation modes of the set of operation modes are associated with different energy usage at the network entity.

27. The apparatus of claim 25, wherein the instructions to receive the set of operation modes are further executable by the processor to cause the apparatus to:
receive a timer value associated with each operation mode of the set of operation modes, and wherein the UE communicates with the network entity according to the first operation mode subsequent to an expiration of a timer that is set based on the timer value associated with the second operation mode.

28. The apparatus of claim 25, wherein the instructions are further executable by the processor to cause the apparatus to:
skip one or more decoding attempts for one or more control information transmissions during the first time interval.

29. An apparatus for wireless communication at a network entity, comprising:
a processor;
memory coupled with the processor; and
instructions stored in the memory and executable by the processor to cause the apparatus to:
transmit, to a first user equipment (UE), a set of operation modes, a first operation mode of the set of operation modes having a first set of communications parameters, and a second operation mode of the set of operation modes having a second set of communications parameters that is different than the first set of communications parameters, each operation mode of the set of operation modes selectable for communications between the UE and the network entity for one or more identified time intervals;
communicate with the first UE according to the first operation mode using the first set of communications parameters;
transmit control information to the first UE that includes an indication to switch to the second operation mode and a first time interval associated with the second operation mode, the indication to switch to the second operation mode based at least in part on an energy usage associated with each of the first operation mode and the second operation mode; and
communicate with the first UE according to the second operation mode using the second set of communications parameters for the first time interval associated with the second operation mode.

30. The apparatus of claim 29, wherein the control information is provided in a group-common downlink control information (GC-DCI) communication that indicates different operation modes for different UEs that receive the GC-DCI.
